(19) United States
(12) Patent Application Publication
(10) Pub. No.: US 2023/0018697 A1
(43) Pub. Date: Jan. 19, 2023

(54) METHOD AND DEVICE FOR WIRELESS COMMUNICATION

(71) Applicant: Xiaobo ZHANG, SHANGHAI (CN)

(72) Inventor: Xiaobo ZHANG, SHANGHAI (CN)

(73) Assignee: SHANGHAI LANGBO COMMUNICATION TECHNOLOGY COMPANY LIMITED, SHANGHAI (CN)

(21) Appl. No.: 17/950,130

(22) Filed: Sep. 22, 2022

Related U.S. Application Data
(63) Continuation of application No. PCT/CN2021/085203, filed on Apr. 2, 2021.

(30) Foreign Application Priority Data
Apr. 3, 2020 (CN) 202010260666.6
Apr. 23, 2020 (CN) 202010325310.6

(51) Int. Cl. H04W 24/08; H04W 24/10

(52) U.S. Cl. CPC H04W 24/08; H04W 24/10

(57) ABSTRACT

The present disclosure provides a method and device for wireless communications, comprising receiving a first service through a first radio bearer; receiving a first signaling, transmitting a first report; and receiving the first service through at least a latter of the first radio bearer and the second radio bearer; wherein when a first condition is satisfied, the first report is transmitted; the first condition comprises that a reception of the first service is modified from the first radio bearer to the second radio bearer; a bearer type of the first radio bearer is different from a bearer type of the second radio bearer, and the bearer type comprises a non-unicast bearer and a unicast bearer. By reasonably determining a radio bearer and transmitting a first report, the present disclosure reduces packet missing rate and interruption and improves reliability.

### CROSS REFERENCE TO RELATED APPLICATIONS

This application is the continuation of the International Patent application No.PCT/CN2021/085203, filed on April 2,2021, which claims the priority benefit of Chinese Patent Application No.202010260666.6, filed on April 3,2020, and claims the priority benefit of Chinese Patent Application No.202010325310.6, filed on April 23,2020, the full disclosure of which is incorporated herein by reference.

### TECHNICAL FIELD

The present disclosure relates to transmission methods and devices in wireless communication systems, and in particular to a transmission method and device for improving system efficiency, optimizing resource utilization, reducing service interruption, increasing service continuity and enhancing reliability in wireless communications.

### BACKGROUND

Application scenarios of future wireless communication systems are becoming increasingly diversified, and different application scenarios have different performance demands on systems. In order to meet different performance requirements of various application scenarios, the 3rd Generation Partner Project (3GPP) Radio Access Network (RAN) #72 plenary session decided to conduct the study of New Radio (NR), or what is called fifth Generation (5G). The work Item (WI) of NR was approved at the 3GPP RAN #75 plenary session to standardize the NR.

In communications, both Long Term Evolution (LTE) and 5G NR involve features of accurate reception of reliable information, optimized energy efficiency ratio, determination of information efficiency, flexible resource allocation, scalable system structure, efficient non-access layer information processing, low service interruption and dropping rate and support for low power consumption, which are of great significance to the maintenance of normal communications between a base station and a UE, reasonable scheduling of resources and balancing of system payload. Those features can be called the cornerstone of high throughout and are characterized in meeting communication requirements of various services, increasing spectrum utilization and improving service quality, which are indispensable in enhanced Mobile BroadBand (eMBB), Ultra Reliable Low Latency Communications (URLLC) and enhanced Machine Type Communications (eMTC). Meanwhile, in the following communication modes, covering Industrial Internet of Things (IIoT), Vehicular to X (V2X), Device to Device communications, Unlicensed Spectrum communications, User communication quality monitoring, network planning optimization, Non-Territorial Networks (NTN), Territorial Networks (TN), Dual connectivity system, and in the mixture of the above communication modes, there are extensive requirements in radio resource management and selection of multi-antenna codebooks as well as in signaling design, neighbor cell management, service management and beamforming. Transmission methods of information are divided into broadcast and unicast, both of which are essential for 5G system for that they are very helpful to meet the above requirements.

With the increase of scenarios and complexity of systems, higher requirements are raised for interruption rate and time delay reduction, reliability and system stability enhancement, service flexibility and power saving. At the same time, compatibility between different versions of different systems should be taken into account when designing the systems.

### SUMMARY

In a variety of communication scenarios, especially in wireless networks supporting broadcast and groupcast, configuring radio bearers for users is involved in specific services. The configured radio bearers can be a unicast bearer and a non-unicast bearer. The non-unicast bearer can be configured in a cell and the unicast bearer can be configured in another cell, and the unicast bearer can be configured at a certain time or the non-unicast bearer at other times, which are important technical content of 5G broadcast and groupcast for greatly increasing flexibility of networks and resource allocation and helping save system resources. But configured like this confronts a series of problems, that is, how and when to configure what kind of radio bearer, when a user moves between different cells, how to select and switch when types of radio bearers are different, and what auxiliary methods are required to perform appropriate switch and selection to reduce interruption of data. Similar problems also exist in a cell when a type of a radio bearer changes. The non-unicast bearer and the unicast bearer are very different, the non-unicast bearer, that is, a broadcast bearer or a groupcast bearer, may be targeted at a cell, a small region, or at a large region with many users, therefore, such bearer is difficult to take each user into account, a serving cell does not even know which users are receiving or using the non-unicast bearer, so that it does not have context information of these users, therefore, it is difficult to optimize and involve each specific user like the unicast bearer, and improper handling may cause the missing of data reception interruption. In addition, if a same service adopts the unicast bearer in a cell and the non-unicast bearer in another cell, transmission of two cells may occur, that is, even the same service may not be synchronized, for example, one is fast and another is slow, or one is more and another is less. Therefore, when a bearer is modified to a bearer with another different type, it will cause interruption or even permanent missing in data transmission, thus resulting in decline of user experience and network performance.

To address the above problem, the present disclosure provides a solution.

It should be noted that if no conflict is incurred, embodiments in any node in the present disclosure and the characteristics of the embodiments are also applicable to any other node, and vice versa. And the embodiments in the present disclosure and the characteristics in the embodiments can be arbitrarily combined if there is no conflict.

The present disclosure provides a method in a first node for wireless communications, comprising:

receiving a first service through a first radio bearer; receiving a first signaling, the first signaling indicating establishing a second radio bearer for the first service;

transmitting a first report; and

receiving the first service through at least a latter of the first radio bearer and the second radio bearer;

herein, when a first condition is satisfied, the first report is transmitted; the first condition comprises that a reception of the first service is modified from the first radio bearer to the second radio bearer; a bearer type of the first radio bearer is different from a bearer type of the second radio bearer, and the bearer type comprises a non-unicast bearer and a unicast bearer; the first report is used for indicating a Service Data Unit (SDU) related to the first service and received through the first radio bearer, and the first report is upper layer control information.

In one embodiment, a problem to be solved in the present disclosure includes: when a radio bearer used for transmitting broadcast and groupcast services is modified between a non-unicast bearer and a unicast bearer, especially from the non-unicast bearer to the unicast bearer, due to the great differences between the non-unicast bearer and the unicast bearer, configuration methods, service capabilities, resource allocations, bearer management, user management, establishments and releases may be different. Conventional methods can’t easily cause data missing during the period of bearer conversion, which will affect the service reception. The present disclosure solves the above problem by transmitting a first report and skillfully associating it with a first radio bearer and a second radio bearer, so that the base station has enough information to correctly transmit data.

In one embodiment, advantages of the above method include that by receiving a first signaling, a user can establish a second radio bearer and switch a reception of the service to the second radio bearer, a transmission of the service will also be modified to the second radio bearer. In such a time interval, by generating a first report, the user informs a serving cell the condition that it performs a reception through a first radio bearer, which is taken as a start of a reception of the second radio bearer, so that the service can be seamlessly modified between two completely different bearers. When the user establishes a second radio bearer, the service can be continuously received as soon as it is modified from the first radio bearer to the second radio bearer, so as to avoid the interruption of data, which is conducive to reducing time delay. Besides, unlike other additional steps, the methods proposed in the present disclosure are also advantageous in complexity.

Specifically, according to one aspect of the present disclosure, the first report is an RRC signaling, the first report comprises a first identity, the first identity is used for determining a PDCP SDU related to the first service and received after a first missing PDCP SDU through the first radio bearer.

Specifically, according to one aspect of the present disclosure, the first report is an RRC signaling, the first report comprises a second identity, the second identity is used for determining a first time window, and the first time window is a time window related to the first service and corresponding to a last SDU received through the first radio bearer.

Specifically, according to one aspect of the present disclosure, the first report is a PDCP status report, a first status variable group is a subset of a set consists of all state variables of a PDCP entity associated with the second radio bearer, and the first signaling indicates that a value of a status variable in the first status variable group is determined by a value of a status variable of a PDCP entity associated with the first radio bearer; the first transmitter generates the first report according to a PDCP entity associated with the second radio bearer, and the first transmitter transmits the first report through a radio bearer whose bearer type is unicast bearer in the first radio bearer and the second radio bearer.

Specifically, according to one aspect of the present disclosure, the first report is a PDCP status report, the first transmitter generates the first report according to a PDCP entity associated with the first radio bearer, and the first transmitter transmits the first report through a radio bearer whose bearer type is unicast bearer in the first radio bearer and the second radio bearer.

Specifically, according to one aspect of the present disclosure, comprising:

the first receiver, which receives a second signaling;

the second signaling indicates that a transmission of the first service is modified from the first radio bearer to the second radio bearer.

Specifically, according to one aspect of the present disclosure, comprising:

the first transmitter, which transmits first information, the first information being used for triggering the first signaling.

Specifically, according to one aspect of the present disclosure, comprising:

the first receiver, which receives a first data set through the first radio bearer and the second radio bearer respectively, the first report being used for determining that the first data set is transmitted through the second radio bearer.

In one embodiment, characteristics of the above method include that an RRC is a Radio Resource Control.

In one embodiment, characteristics of the above method include that a PDCP is a Packet Data Convergence Protocol.

In one embodiment, characteristics of the above method include that an SDU is a Service Data Unit.

Specifically, according to one aspect of the present disclosure, the first node is a UE.

Specifically, according to one aspect of the present disclosure, the first node is a IoT terminal.

Specifically, according to one aspect of the present disclosure, the first node is a relay.

Specifically, according to one aspect of the present disclosure, the first node is a vehicle terminal.

Specifically, according to one aspect of the present disclosure, the first node is an aircraft.

The present disclosure provides a method in a second node for wireless communications, comprising:

transmitting a first signaling, the first signaling indicating a second radio bearer establishing a first service; the first service being transmitted through a first radio bearer;

receiving a first report; and

a receiver of the first signaling receiving the first service through at least a latter of the first radio bearer and the second radio bearer;

herein, when a first condition is satisfied, the receiver of the first signaling transmits the first report; the first condition comprises that a reception of the first service is modified from the first radio bearer to the second radio bearer; a bearer type of the first radio bearer is different from a bearer type of the second radio bearer, and the bearer type comprises a non-unicast bearer and a unicast bearer; the first report is used for indicating an SDU related to the first service and received through the first radio bearer, and the first report is upper layer control information.

Specifically, according to one aspect of the present disclosure, the first report is an RRC signaling, the first report comprises a first identity, the first identity is used for determining a PDCP SDU related to the first service and received after a first missing PDCP SDU through the first radio bearer.

Specifically, according to one aspect of the present disclosure, the first report is an RRC signaling, the first report comprises a second identity, the second identity is used for determining a first time window, and the first time window is a time window related to the first service and corresponding to a last SDU received through the first radio bearer.

Specifically, according to one aspect of the present disclosure, the first report is a PDCP status report, a first status variable group is a subset of a set consists of all status variables of a PDCP entity associated with the second radio bearer, and the first signaling indicates that a value of a status variable in the first status variable group is determined by a value of a status variable of a PDCP entity associated with the first radio bearer; a transmitter of the first report generates the first report according to a PDCP entity associated with the second radio bearer, and the transmitter of the first report transmits the first report through a radio bearer whose bearer type is unicast bearer in the first radio bearer and the second radio bearer.

Specifically, according to one aspect of the present disclosure, the first report is a PDCP status report, a transmitter of the first report generates the first report according to a PDCP entity associated with the first radio bearer, and the transmitter of the first report transmits the first report through a radio bearer whose bearer type is unicast bearer in the first radio bearer and the second radio bearer.

Specifically, according to one aspect of the present disclosure, comprising:

the second transmitter, which transmits a second signaling;

the second signaling indicates that a transmission of the first service is modified from the first radio bearer to the second radio bearer.

Specifically, according to one aspect of the present disclosure, comprising:

the second receiver, which receives first information, the first information being used for triggering the first signaling.

Specifically, according to one aspect of the present disclosure, comprising:

the second transmitter, which transmits a first data set through the first radio bearer and the second radio bearer respectively, the first report being used for determining that the first data set is transmitted through the second radio bearer.

Specifically, according to one aspect of the present disclosure, the second node is a base station.

Specifically, according to one aspect of the present disclosure, the second node is a relay.

Specifically, according to one aspect of the present disclosure, the second node is a vehicle terminal.

Specifically, according to one aspect of the present disclosure, the second node is an aircraft.

Specifically, according to one aspect of the present disclosure, the second node is a group header.

Specifically, according to one aspect of the present disclosure, the second node is a satellite.

The present disclosure provides a first node for wireless communications, comprising:

a first receiver, which receives a first service through a first radio bearer; and receives a first signaling, the first signaling indicating establishing a second radio bearer for the first service;

a first transmitter, which transmits a first report; and

the first receiver, which receives the first service through at least a latter of the first radio bearer and the second radio bearer;

herein, when a first condition is satisfied, the first transmitter transmits the first report; the first condition comprises that a reception of the first service is modified from the first radio bearer to the second radio bearer; a bearer type of the first radio bearer is different from a bearer type of the second radio bearer, and the bearer type comprises a non-unicast bearer and a unicast bearer; the first report is used for indicating an SDU related to the first service and received through the first radio bearer, and the first report is upper layer control information.

The present disclosure provides a second node for wireless communications, comprising:

a second transmitter, which transmits a first signaling, the first signaling indicating a second radio bearer establishing a first service; the first service being transmitted through a first radio bearer;

a second receiver, which receives a first report; and

a receiver of the first signaling receiving the first service through at least a latter of the first radio bearer and the second radio bearer;

herein, when a first condition is satisfied, the receiver of the first signaling transmits the first report; the first condition comprises that a reception of the first service is modified from the first radio bearer to the second radio bearer; a bearer type of the first radio bearer is different from a bearer type of the second radio bearer, and the bearer type comprises a non-unicast bearer and a unicast bearer; the first report is used for indicating an SDU related to the first service and received through the first radio bearer, and the first report is upper layer control information.

In one embodiment, the present disclosure has the following advantages over conventional schemes:

when a user moves from a cell transmitting broadcast and groupcast services through a non-unicast bearer to a cell transmitting broadcast and groupcast services through a unicast bearer, or when a cell transmitting broadcast and groupcast services through a non-unicast bearer is modified to transmitting same services through a unicast bearer, the problems of data missing or even interruption will be confronted in the process of conversion. Because in a cell employing a non-unicast bearer, the network may not keep the user's context, while the non-unicast may not support feedback of the user, so it is difficult for a serving cell to grasp the user’s reception condition. When a bearer type of a serving cell is modified, data received by each user may be different, if a new independent unicast bearer is established directly according to conventional methods, then data missing is hard to be avoided. When the user hands over, especially when adopting conditional handover, the time when the user hands over is uncertain, because the handover is determined independently by the user, so it is more difficult for the serving cell to grasp the reception condition of the user. When the user enters into a new cell or needs to employ a unicast bearer to receive data in this cell, how to enable a newly established bearer to connect with data transmitted previously by a non-unicast bearer is involved. By using a first report and associating it with a first radio bearer and a second radio bearer, the present disclosure provides enough information for the serving cell, thus solving the above problems and avoiding the problems caused by conventional methods. In addition, the methods proposed in the present disclosure can provide a solution for conversion of a non-unicast bearer to a unicast bearer with completely different configurations, which has wide applicability and flexibility, and is conducive to improving resource utilization and service quality.

In one embodiment, the present disclosure has the following advantages over conventional schemes:

when a user moves from a cell transmitting broadcast and groupcast services through a unicast bearer to a cell transmitting broadcast and groupcast services through a non-unicast bearer, or when a cell transmitting broadcast and groupcast services through a unicast bearer is modified to transmitting same services through a non-unicast bearer, the problems of data missing or even interruption will be confronted in the process of conversion. When multiple unicast users receive a same broadcast and groupcast service, due to differences of channel characteristics, resource allocation, device capabilities and priorities of users, situation of service transmission will be different. When data of some users are still in buffer of a serving cell, data of the others has been transmitted to the user side, when unicast services are uniformly modified to non-unicast bearers, some users, such as those who receive slowly, do not receive sufficient data, thus resulting in decline in receive quality. This is a difficult problem in conventional methods. The present disclosure performs comprehensively evaluation by using a first report generated by each user, and provides sufficient information for a serving cell to configure with a non-unicast bearer, the configured non-unicast bearer and subsequent data transmission can be compatible with data reception condition of all previous unicast users, thus solving the above problems and avoiding problems brought by conventional methods.

The present disclosure provides a method in a first node for wireless communications, comprising:

receiving a first measurement configuration group and a first report configuration group; and performing a first channel measurement on a first reference signal set; and

determining that a first condition is satisfied, as a response that the first condition is satisfied, transmitting a first report information group, the first report configuration group indicating the first condition;

herein, the first measurement configuration group comprises a first measurement configuration sub-group; the first measurement configuration sub-group indicates the first reference signal set; the first measurement configuration sub-group is a non-unicast upper layer signaling, and the first report configuration group is a unicast upper layer signaling; and the first report information group comprises a result of the first channel measurement.

In one embodiment, a problem to be solved in the present disclosure includes: a serving cell of the first node needs to be configured in a feasible way in terms of efficiency, energy consumption and service requirements when conducting measurement configuration, and wrong configuration will result in waste of resources, efficiency decline, power consumption caused by promotion of unnecessary measurement, or unable to be configured with conventional methods; in addition, since service, position, channel and mobility requirement of each user is different, thus a specific configuration is required. The present disclosure transfers measurement configuration information in a broadcast way while transmits report configuration in a unicast way, and combines these two organically through a first condition, thus solving the above problems.

Specifically, according to one aspect of the present disclosure, a second channel measurement is performed on a second reference channel set;

herein, the first measurement configuration group comprises a second measurement configuration sub-group; the second measurement configuration sub-group indicates the second reference signal set; the second measurement configuration sub-group is a unicast upper layer signaling; and the first report information group comprises a result of the second channel measurement.

Specifically, according to one aspect of the present disclosure, the first channel measurement performed on the first reference signal set is performed in a first time window; and the second channel measurement on the second reference signal set is performed in a second time window.

Specifically, according to one aspect of the present disclosure, comprising:

receiving Q candidate measurement configuration sub-group(s); and

transmitting a first identity set;

herein, the Q candidate measurement configuration sub-group(s) comprises(respectively comprise) Q identity(identities), the first identity set comprises Q1 identity(identities), Q and Q1 being positive integers, the Q1 identity(identities) is(are) subset(s) of the Q identity (identities), and the first identity set is used for determining the second measurement configuration sub-group.

Specifically, according to one aspect of the present disclosure, a transmission delay from the second reference signal set to the first node is less than a first threshold; and a transmission delay from the first reference signal set to the first node is not less than the first threshold.

Specifically, according to one aspect of the present disclosure, a transmitter of the first measurement configuration sub-group and the transmitter of the first report configuration group are two serving cells.

Specifically, according to one aspect of the present disclosure, the first measurement configuration sub-group is associated with a first radio bearer, and the first radio bearer is used for bearing a non-unicast data service.

Specifically, according to one aspect of the present disclosure, comprising:

receiving first time information, the first time information being used for determining the first report information group.

Specifically, according to one aspect of the present disclosure, comprising:

transmitting a first signal; and

receiving a second signal;

herein, the first signal is used for triggering the second signal, and the first condition includes that the second signal is received.

Specifically, according to one aspect of the present disclosure, the first node is a UE.

Specifically, according to one aspect of the present disclosure, the first node is a IoT terminal.

Specifically, according to one aspect of the present disclosure, the first node is a relay.

Specifically, according to one aspect of the present disclosure, the first node is a vehicle terminal.

Specifically, according to one aspect of the present disclosure, the first node is an aircraft.

The present disclosure provides a method in a second node for wireless communications, comprising:

transmitting a first measurement configuration group and a first report configuration group; and

receiving a first report information group, the first report configuration group indicating a first condition; the first condition being used for triggering a transmission of the first report information group;

herein, the first measurement configuration group comprises a first measurement configuration sub-group; the first measurement configuration sub-group indicates a first reference signal set; the first reference signal set is used for performing a first channel measurement; the first measurement configuration sub-group is a non-unicast upper layer signaling, and the first report configuration group is a unicast upper layer signaling; the first report information group comprises a result of the first channel measurement.

Specifically, according to one aspect of the present disclosure, a receiver of the first measurement configuration group performs a second channel measurement on a second reference signal set;

herein, the first measurement configuration group comprises a second measurement configuration sub-group; the second measurement configuration sub-group indicates the second reference signal set; the second measurement configuration sub-group is a unicast upper layer signaling; and the first report information group comprises a result of the second channel measurement.

Specifically, according to one aspect of the present disclosure, the first channel measurement on the first reference signal set is performed by a receiver of the first measurement configuration group in a first time window; the second channel measurement on the second reference signal set is performed by a receiver of the first measurement configuration group in a second time window.

Specifically, according to one aspect of the present disclosure, comprising:

transmitting Q candidate measurement configuration sub-group(s); and

receiving a first identity set;

herein, the Q candidate measurement configuration sub-group(s) comprises(respectively comprise) Q identity(identities), the first identity set comprises Q1 identity(identities), Q and Q1 being positive integers, the Q1 identity(identities) is(are) subset(s) of the Q identity(identities), and the first identity set is used for determining the second measurement configuration sub-group.

Specifically, according to one aspect of the present disclosure, a transmission delay from the second reference signal set to a receiver of the first measurement configuration group is less than a first threshold; and a transmission delay from the first reference signal set to a receiver of the first measurement configuration group is not less than the first threshold.

Specifically, according to one aspect of the present disclosure, the first measurement configuration sub-group is associated with a first radio bearer, and the first radio bearer is used for bearing non-unicast data service.

Specifically, according to one aspect of the present disclosure, comprising:

transmitting first time information, the first time information being used for determining the first report information group.

Specifically, according to one aspect of the present disclosure, comprising:

receiving a first signal; and

transmitting a second signal;

herein, the first signal is used for triggering the second signal, and the first condition includes that the second signal is received.

Specifically, according to one aspect of the present disclosure, the second node is a base station.

Specifically, according to one aspect of the present disclosure, the second node is a relay.

Specifically, according to one aspect of the present disclosure, the second node is a vehicle terminal.

Specifically, according to one aspect of the present disclosure, the second node is an aircraft.

Specifically, according to one aspect of the present disclosure, the second node is a group header.

Specifically, according to one aspect of the present disclosure, the second node is a satellite.

The present disclosure provides a first node for wireless communications, comprising:

a first receiver, which receives a first measurement configuration group and a first report configuration group; and performs a first channel measurement on a first reference signal set; and

a first transmitter, which determines that a first condition is satisfied, as a response that the first condition is satisfied, transmits a first report information group, the first report configuration group indicating the first condition;

herein, the first measurement configuration group comprises a first measurement configuration sub-group; the first measurement configuration sub-group indicates the first reference signal set; the first measurement configuration sub-group is a non-unicast upper layer signaling, and the first report configuration group is a unicast upper layer signaling; and the first report information group comprises a result of the first channel measurement.

The present disclosure provides a second node for wireless communications, comprising:

a second transmitter, which transmits a first measurement configuration group and a first report configuration group; and

a second receiver, which receives a first report information group, the first report configuration group indicating a first condition; the first condition being used for triggering a transmission of the first report information group;

herein, the first measurement configuration group comprises a first measurement configuration sub-group; the first measurement configuration sub-group indicates a first reference signal set; the first reference signal set is used for performing a first channel measurement; the first measurement configuration sub-group is a non-unicast upper layer signaling, and the first report configuration group is a unicast upper layer signaling; the first report information group comprises a result of the first channel measurement.

In one embodiment, the present disclosure has the following advantages over conventional schemes:

in an RRC connection state, conventional measurement configuration performed in unicast way confronts the problems of low efficiency, especially when there are large number of users in a cell, for example, in an NTN cell or there exists a large number of IoT users, measurement indication cannot be configured for a large number of users at the same time, and at this time, performing measurement configuration in a broadcast way is more efficient than the conventional methods; on the other hand, different users have different characteristics, including different positions, different channel conditions, different services and capabilities, and requirements for performing different report strategies, therefore, configuration needs to be performed in a unicast way. The methods proposed in the present disclosure organically combines the two through a first condition and a first reference signal set, which has the advantages of improving efficiency and ensuring different requirements for different users at the same time;

compared with conventional methods, by transmitting a first measurement configuration sub-group and a second measurement configuration sub-group in different ways, the present disclosure can not only realize universality, efficiency, accessibility of the configuration, but also take specific conditions and specific features of each user into account, so that it has flexibility and can configure all users in a cell at one time;

when a user and a serving cell do not have a signaling bearer, and the conventional methods cannot configure measurement for the user, while through broadcast proposed in the present disclosure, and further in the case of multiple cells, especially in the case of dual-connection, a cell without a signaling bearer is configured with a measurement through a broadcast way, while a cell with a signaling bearer is configured with a report through a unicast way, especially for unified configuration for reporting, all of which are impossible in conventional methods for not only taking characteristics of cell transmission into account, but also meeting various requirements of measurement and report.

### BRIEF DESCRIPTION OF THE DRAWINGS

Other features, objects and advantages of the present disclosure will become more apparent from the detailed description of non-restrictive embodiments taken in conjunction with the following drawings:

FIG. 1A illustrates a flowchart of receiving a first signaling and transmitting a first report according to one embodiment of the present disclosure.

FIG. 1B illustrates a flowchart of receiving a first measurement configuration group and a first report configuration group and transmitting a first report information group according to one embodiment of the present disclosure.

FIG. 2 illustrates a schematic diagram of a network architecture according to one embodiment of the present disclosure.

FIG. 3 illustrates a schematic diagram of a radio protocol architecture of a user plane and a control plane according to one embodiment of the present disclosure.

FIG. 4 illustrates a schematic diagram of a first node and a second node according to one embodiment of the present disclosure.

FIG. 5A illustrates a flowchart of wireless communications according to one embodiment of the present disclosure.

FIG. 5B illustrates a flowchart of wireless communications according to one embodiment of the present disclosure.

FIG. 6A illustrates a flowchart of wireless communications according to one embodiment of the present disclosure.

FIG. 6B illustrates a flowchart of wireless communications according to one embodiment of the present disclosure.

FIG. 7A illustrates a flowchart of wireless communications according to one embodiment of the present disclosure.

FIG. 7B illustrates a flowchart of wireless communications according to one embodiment of the present disclosure.

FIG. 8A illustrates a schematic diagram of a first time window according to one embodiment of the present disclosure.

FIG. 8B illustrates a flowchart of wireless communications according to one embodiment of the present disclosure.

FIG. 9A illustrates a schematic diagram of a first report used for determining that a first data set is transmitted through a second radio bearer according to one embodiment of the present disclosure.

FIG. 9B illustrates a schematic diagram of a first measurement configuration sub-group and a first report configuration group according to one embodiment of the present disclosure.

FIG. 10A illustrates a schematic diagram of a first report used for indicating an SDU related to a first service and received through a first radio bearer according to one embodiment of the present disclosure.

FIG. 10B illustrates a schematic diagram of a first measurement configuration sub-group associated with a first radio bearer according to one embodiment of the present disclosure.

FIG. 11 illustrates a schematic diagram of a processing device in a first node according to one embodiment of the present disclosure.

FIG. 12 illustrates a schematic diagram of a processing device in a second node according to one embodiment of the present disclosure.

FIG. 13 illustrates a schematic diagram of a processing device in a first node according to one embodiment of the present disclosure.

FIG. 14 illustrates a schematic diagram of a processing device in a second node according to one embodiment of the present disclosure.

### DESCRIPTION OF THE EMBODIMENTS

The technical scheme of the present disclosure is described below in further details in conjunction with the drawings. It should be noted that the embodiments of the present disclosure and the characteristics of the embodiments may be arbitrarily combined if no conflict is caused.

### Embodiment 1A

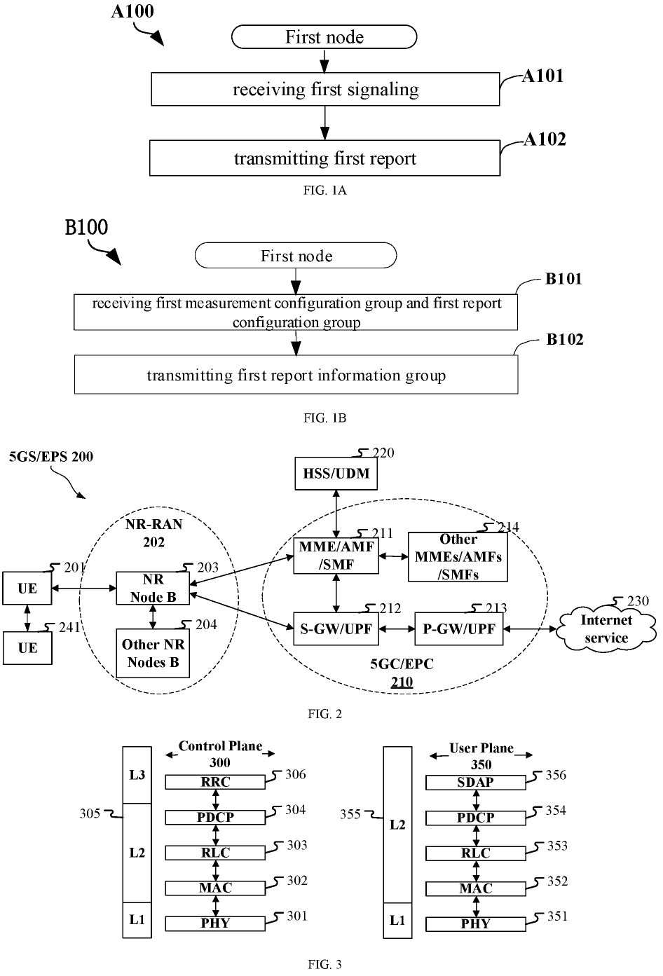

Embodiment 1A illustrates a flowchart of receiving a first signaling and transmitting a first report according to one embodiment of the present disclosure, as shown in FIG. 1A. In FIG. 1, each box represents a step. Particularly, the sequential order of steps in these boxes does not necessarily mean that the steps are chronologically arranged.

In Embodiment 1A, a first node in the present disclosure receives a first signaling in step A101; and transmits a first report in step A102;

herein, the first node receives a first service through a first radio bearer; the first signaling indicates establishing a second radio bearer for the first service; and the first node receives the first service through at least a latter of the first radio bearer and the second radio bearer; herein, when a first condition is satisfied, the first node transmits the first report; the first condition comprises that a reception of the first service is modified from the first radio bearer to the second radio bearer; a bearer type of the first radio bearer is different from a bearer type of the second radio bearer, and the bearer type comprises a non-unicast bearer and a unicast bearer; the first report is used for indicating an SDU related to the first service and received through the first radio bearer, and the first report is upper layer control information.

In one embodiment, the first node is a UE.

In one embodiment, the first signaling comprises control-panel control information.

In one embodiment, the first signaling comprises user-panel control information.

In one embodiment, the first signaling comprises an RRC signaling.

In one embodiment, the first signaling comprises a Medium Access Control Control Element (MAC CE) signaling.

In one embodiment, the first signaling comprises a Downlink Control Information (DCI) signaling.

In one embodiment, the first signaling comprises PDCP control information.

In one embodiment, the first signaling comprises Radio Link Control (RLC) control information.

In one embodiment, the first signaling comprises an RRCReconfiguration message.

In one embodiment, the first signaling comprises an RRCConnectionReconfiguration message.

In one embodiment, the first signaling comprises an SCPTMConfiguration message.

In one embodiment, the first signaling comprises a System Information Block (SIB).

In one embodiment, the first signaling comprises an SIB1.

In one embodiment, the first signaling comprises an SIB14.

In one embodiment, the first signaling comprises an SIB15.

In one embodiment, the first signaling comprises an SIB16.

In one embodiment, the first signaling comprises an SIB17.

In one embodiment, the first signaling comprises an SIB18.

In one embodiment, the first signaling comprises an SIB19.

In one embodiment, the first signaling comprises an SIB20.

In one embodiment, the first signaling is transmitted in a broadcast way.

In one embodiment, a logical channel occupied by the first signaling comprises a Broadcast Control Channel (BCCH).

In one embodiment, a logical channel occupied by the first signaling comprises a Multicast Control Channel (MCCH).

In one embodiment, a logical channel occupied by the first signaling comprises a Single Cell Multicast Control Channel (SC-MCCH).

In one embodiment, a logical channel occupied by the first signaling comprises a Common Control Channel (CCCH).

In one embodiment, the first signaling is transmitted in a unicast way.

In one embodiment, a logical channel occupied by the first signaling comprises a Dedicated Control Channel (DCCH).

In one embodiment, a physical channel occupied by the first signaling comprises a Physical Downlink Shared Channel (PDSCH).

In one embodiment, the first radio bearer is a Multicast Radio Bearer (MRB).

In one embodiment, the first radio bearer is a Single Cell Multicast Radio Bearer (SC-MRB).

In one embodiment, the first radio bearer is a Single Cell Point to Multipoint (SC-PTM) MRB.

In one embodiment, the first radio bearer is a Data Radio Bearer (DRB).

In one embodiment, the second radio bearer is an MRB.

In one embodiment, the second radio bearer is an SC-MRB.

In one embodiment, the second radio bearer is an SC-PTM MRB.

In one embodiment, the second radio bearer is a DRB.

In one embodiment, the non-unicast bearer comprises an MRB, an SC-MRB, an SC-PTM MRB, and a DRB indicated as multicast.

In one embodiment, the unicast bearer comprises a DRB not indicated as multicast.

In one embodiment, the first node receives the first service through the first radio bearer and the second radio bearer.

In one embodiment, the first node receives the first service first through the first radio bearer, then through the first radio bearer and the second radio bearer.

In one embodiment, the first node receives the first service first through the first radio bearer and then through the second radio bearer.

In one embodiment, the first service comprises a broadcast service.

In one embodiment, the first service comprises a groupcast service.

In one embodiment, the first service comprises a Multicast/Broadcast Service (MBS).

In one embodiment, the first service comprises a Multicast/Broadcast Multimedia Service (MBMS).

In one embodiment, the first service comprises an chanced Multicast/Broadcast Multimedia Service (eMBMS).

In one embodiment, the first service comprises a further chanced Multicast/Broadcast Multimedia Service (feMBMS).

In one embodiment, the first service comprises a further chanced Multicast/Broadcast Multimedia Service (fefeMBMS).

In one embodiment, the first service comprises at least one MBS session.

In one embodiment, the first service comprises a Broadcast communication service.

In one embodiment, the first service comprises a Multicast communication service.

In one embodiment, the first service comprises at least one MBS flow transmission.

In one embodiment, the first service comprises a PDU session.

In one embodiment, the first service comprises an MBS PDU session.

In one embodiment, the first service comprises an MBMS PDU session.

In one embodiment, an MBS Flow comprised in the first service is mapped onto the first radio bearer.

In one embodiment, an MBS Flow comprised in the first service is associated with the first radio bearer.

In one embodiment, the first radio bearer is used for transmitting an MBS Flow comprised in the first service.

In one embodiment, the first service comprises at least one QoS flow transmission.

In one embodiment, a QoS Flow comprised in the first service is mapped onto the first radio bearer.

In one embodiment, a QoS Flow comprised in the first service is associated with the first radio bearer.

In one embodiment, the first radio bearer is used for transmitting a QoS Flow comprised in the first service.

In one embodiment, an MBS Flow comprised in the first service is mapped onto the second radio bearer.

In one embodiment, an MBS Flow comprised in the first service is associated with the second radio bearer.

In one embodiment, the second radio bearer is used for transmitting an MBS Flow comprised in the first service.

In one embodiment, a QoS Flow comprised in the first service is mapped onto the second radio bearer.

In one embodiment, a QoS Flow comprised in the first service is associated with the second radio bearer.

In one embodiment, the second radio bearer is used for transmitting a QoS Flow comprised in the first service.

In one embodiment, the first node receives an MBS Flow corresponding to the first service through at least a latter of the first radio bearer and the second radio bearer.

In one embodiment, the first node is connected with 5G Core (5GC) network.

In one embodiment, the first node is connected with EN-DC Core network.

In one embodiment, the first node is served by a first cell and a second cell, when a serving cell of the first node is the first cell, the first node receives the first service through the first radio bearer, and when a serving cell of the first node is a second cell, the first node receives the first service through the second radio bearer.

In one subembodiment of the above embodiment, the first node is modified from the first cell to the second cell.

In one subembodiment of the above embodiment, the first node is conditionally modified from the first cell to the second cell.

In one subembodiment of the above embodiment, the first node reselects from the first cell to the second cell.

In one subembodiment of the above embodiment, the first signaling is used for indicating that a serving cell of the first node is modified from the first cell to the second cell.

In one embodiment, a serving cell of the first node is a third cell, the third cell uses the first radio bearer to transmit the first service in a first duration, and the third cell uses the second radio bearer to transmit the first service in a second duration.

In one subembodiment of the above embodiment, the first duration and the second duration are orthogonal in time domain.

In one embodiment, the first radio bearer is a non-unicast bearer, and the second radio bearer is a unicast bearer.

In one embodiment, the first radio bearer is a unicast bearer, and the second radio bearer is a non-unicast bearer.

In one embodiment, the first report is control-plane control information.

In one embodiment, the first report is user-plane control information.

In one embodiment, the first report comprises an RRC signaling.

In one embodiment, the first report comprises a MAC CE signaling.

In one embodiment, the first report comprises PDCP control information.

In one embodiment, the first report comprises RLC control information.

In one embodiment, the first report comprises a PDCP Status Report.

In one embodiment, the first report comprises an RRCReconfigurationComplete.

In one embodiment, the first report comprises an RRCConnectionReconfigurationComplete.

In one embodiment, the first report comprises an RRCSetupRequest.

In one embodiment, the first report comprises an RRCConnectionSetupRequest.

In one embodiment, the first report comprises an RRCResumeRequest.

In one embodiment, the first report comprises an RRCConnectionResumeRequest.

In one embodiment, the first report comprises an RRCResumeRequest1.

In one embodiment, the first report comprises an RRCConnectionResumeRequest1.

In one embodiment, the first report comprises an RRCReestablishmentRequest.

In one embodiment, the first report comprises an RRCConnectionReestablishmentRequest.

In one embodiment, the first report comprises an MBMSInterestIndication.

In one embodiment, the first report comprises a ueAssistanceInformation.

In one embodiment, the first report comprises a dedicatedSIBRequest-r16.

In one embodiment, the first report comprises a ueInformationResponse-r16.

In one embodiment, the first report comprises a ueAssistanceInformationEUTRA-r16.

In one embodiment, the first report comprises an MBMSInterestIndication-r17.

In one embodiment, the first report comprises a ueAssistanceInformation-r17.

In one embodiment, a logical channel occupied by the first report comprises a DCCH.

In one embodiment, a logical channel occupied by the first report comprises a CCCH.

In one embodiment, a physical channel occupied by the first report comprises a Physical Uplink Shared Channel (PUSCH).

In one embodiment, the first signaling indicates that a transmission of the first service is modified from the first radio bearer to the second radio bearer.

In one embodiment, the first signaling indicates that a QoS flow comprised in the first service is changed from a PDCP entity associated with the first radio bearer to a PDCP entity associated with the second radio bearer.

In one embodiment, the first signaling indicates that a QoS flow mapped onto the second radio bearer comprises a QoS flow comprised in the first service.

In one embodiment, the first signaling indicates that a QoS flow of the first service is added to a QoS flow mapped onto the second radio bearer through an SDAP-Config cell.

In one embodiment, the first signaling indicates that a QoS flow of the first service is added to a QoS flow mapped onto the second radio bearer through a mappedQoS-FlowsToAdd cell.

In one embodiment, the phrase that the first signaling indicates establishing a second radio bearer for the first service includes the following meaning: the first signaling indicates establishing of the second radio bearer.

In one embodiment, the phrase that the first signaling indicates establishing a second radio bearer for the first service includes the following meaning: the second radio bearer is an existing radio bearer, and the first signaling indicates that a QoS flow of the first service is mapped onto the second radio bearer.

In one embodiment, the first signaling indicates that a transmission of the first service is modified from the second radio bearer to the first radio bearer.

In one embodiment, the first signaling indicates that a QoS flow comprised in the first service is changed from a PDCP entity associated with the second radio bearer to a PDCP entity associated with the first radio bearer.

In one embodiment, the first signaling indicates that a QoS flow mapped onto the first radio bearer comprises a QoS flow comprised in the first service.

In one embodiment, the first signaling indicates that a QoS flow of the first service is added to a QoS flow mapped onto the first radio bearer through an SDAP-Config cell.

In one embodiment, the first signaling indicates that a QoS flow of the first service is added to a QoS flow mapped onto the first radio bearer through a mappedQoS-FlowsToAdd cell.

In one embodiment, the first signaling indicates that a QoS flow of the first service is released from a mapped QoS flow of the first radio bearer through a mappedQoS-FlowsToRelease cell.

In one embodiment, the first signaling indicates releasing the first radio bearer.

In one embodiment, the first signaling indicates releasing a mapping of the first radio bearer and a QoS flow of the first service.

In one embodiment, the first signaling indicates releasing the second radio bearer.

In one embodiment, the first signaling indicates releasing a mapping of the second radio bearer and a QoS flow of the first service.

In one embodiment, the first condition comprises that a reception of the first service is modified from the first radio bearer to the second radio bearer.

In one embodiment, the phrase that the first condition comprises that a reception of the first service is modified from the first radio bearer to the second radio bearer includes the following meaning: the first node receives the first service through the second radio bearer.

In one embodiment, the phrase that the first condition comprises that a reception of the first service is modified from the first radio bearer to the second radio bearer includes the following meaning: the first node starts receiving the first service through the second radio bearer.

In one embodiment, the phrase that the first condition comprises that a reception of the first service is modified from the first radio bearer to the second radio bearer includes the following meaning: the second radio bearer is established.

In one embodiment, the phrase that the first condition comprises that a reception of the first service is modified from the first radio bearer to the second radio bearer includes the following meaning: a PDCP entity associated with the second radio bearer is established.

In one embodiment, the phrase that the first condition comprises that a reception of the first service is modified from the first radio bearer to the second radio bearer includes the following meaning: a PDCP entity of the second radio bearer is established.

In one embodiment, the phrase that the first condition comprises that a reception of the first service is modified from the first radio bearer to the second radio bearer includes the following meaning: the first radio bearer is determined as a secondary bearer, and the first radio bearer is determined as a primary bearer.

In one embodiment, the phrase that the first condition comprises that a reception of the first service is modified from the first radio bearer to the second radio bearer includes the following meaning: the first node receives an explicit indication that a reception of the first service is modified from the first radio bearer to the second radio bearer.

In one embodiment, the phrase that the first condition comprises that a reception of the first service is modified from the first radio bearer to the second radio bearer includes the following meaning: stops receiving the first service from the first radio bearer, and starts receiving the first service from the second radio bearer.

In one embodiment, the phrase that the first condition comprises that a reception of the first service is modified from the first radio bearer to the second radio bearer includes the following meaning: stops receiving the first service from the first radio bearer, and the second radio bearer is established.

In one embodiment, the phrase that the first condition comprises that a reception of the first service is modified from the first radio bearer to the second radio bearer includes the following meaning: stops receiving the first service from the first radio bearer, and an PDCP entity of the second radio bearer is established.

In one embodiment, the phrase that the first condition comprises that a reception of the first service is modified from the first radio bearer to the second radio bearer includes the following meaning: the first node requests to receive the first service through the second radio bearer.

In one embodiment, the phrase that the first condition comprises that a reception of the first service is modified from the first radio bearer to the second radio bearer includes the following meaning: the first node receives the first service with a non-unicast bearer, and a serving cell of the first node indicates that the first service needs to be received with a unicast bearer.

### Embodiment 1B

Embodiment 1B illustrates a flowchart of receiving a first measurement configuration group and a first report configuration group and transmitting a first report information group according to one embodiment of the present disclosure, as shown in FIG. 1B. In FIG. 1B, each box represents a step. Particularly, the sequential order of steps in these boxes does not necessarily mean that the steps are chronologically arranged.

In Embodiment 1B, a first node in the present disclosure receives a first measurement configuration group and a first report configuration group in step B101, and performs a first channel measurement on a first reference signal set; determines that a first condition is satisfied in step B102, as a response that the first condition is satisfied, transmits a first report information group, the first report configuration group indicates the first condition;

herein, the first measurement configuration group comprises a first measurement configuration sub-group; the first measurement configuration sub-group indicates the first reference signal set; the first measurement configuration sub-group is a non-unicast upper layer signaling, and the first report configuration group is a unicast upper layer signaling; and the first report information group comprises a result of the first channel measurement.

In one embodiment, the first node is a UE.

In one embodiment, the first measurement configuration sub-group is a groupcast upper layer signaling.

In one embodiment, the first measurement configuration sub-group is a broadcast upper layer signaling.

In one embodiment, the first measurement configuration sub-group is an SIB.

In one embodiment, the first measurement configuration sub-group comprises an SIB2.

In one embodiment, the first measurement configuration sub-group comprises an SIB3.

In one embodiment, the first measurement configuration sub-group comprises an SIB4.

In one embodiment, the first measurement configuration sub-group comprises an SIB5.

In one embodiment, the first measurement configuration sub-group comprises an SIB10.

In one embodiment, the first report information group comprises an identity of the first measurement configuration sub-group.

In one embodiment, the identity of the first measurement configuration sub-group is an integer.

In one embodiment, the first node is in an RRC connection mode.

In one embodiment, the first node is in an RRC inactive mode.

In one embodiment, the first measurement configuration group and the first report configuration group are RRC layer signalings.

In one embodiment, the first measurement configuration group and the first report configuration group are encapsulated in different RRC layer signalings.

In one embodiment, the first measurement configuration sub-group is transmitted through a Broadcast Channel (BCH).

In one embodiment, the first measurement configuration sub-group is transmitted through a PDSCH channel.

In one embodiment, the first measurement configuration sub-group is transmitted through a PDCCH channel.

In one embodiment, the first report configuration group is transmitted through a BCH channel.

In one embodiment, the first report configuration group is transmitted through a PDSCH channel.

In one embodiment, the first report configuration group is transmitted through a PDCCH channel.

In one embodiment, the first measurement configuration group comprises a MAC layer signaling.

In one embodiment, the first report configuration group comprises a MAC layer signaling.

In one embodiment, the first measurement configuration group comprises MeasConfig.

In one embodiment, the first measurement configuration group comprises a measObjectToAddModList.

In one embodiment, the first measurement configuration group comprises a measIdToAddModList.

In one embodiment, the first measurement configuration sub-group comprises a MeasIdToAddMod.

In one embodiment, the identity of the first measurement configuration sub-group is a measId.

In one embodiment, the first report configuration group comprises a reportConfigToAddModList.

In one embodiment, the first report configuration group comprises a reportConfigId.

In one embodiment, the first report configuration group comprises a reportConfig.

In one embodiment, the first report configuration group comprises a reportConfigNR.

In one embodiment, the first report configuration group comprises a reportConfigInterRAT.

In one embodiment, the first measurement configuration group comprises measConfigSN.

In one embodiment, the first measurement configuration group comprises quantityConfig.

In one embodiment, the first measurement configuration group comprises measGapConfig.

In one embodiment, the first measurement configuration group comprises s-Measure.

In one embodiment, the first measurement configuration group comprises preRegistrationInfoHRPD.

In one embodiment, the first report configuration group comprises reportConfigEUTRA.

In one embodiment, the first measurement configuration group is saved by the first node in VarMeasConfig.

In one embodiment, the first measurement configuration sub-group is saved by the first node in VarMeasConfig.

In one embodiment, the first report information group is saved by the first node in a VarMeasReportList.

In one embodiment, the first reference signal set comprises a synchronization signal.

In one embodiment, a channel occupied by the first reference signal set comprises a Physical Broadcasting CHannel (PBCH).

In one embodiment, the synchronization signal comprises a Primary Synchronization Signal (PSS) and a Secondary Synchronization Signal (SSS).

In one embodiment, the first reference signal set comprises a Reference Signal (RS).

In one embodiment, the first reference signal set comprises a Cell Reference Signal (CRS).

In one embodiment, the first reference signal set comprises a Channel State Information-Reference Signal (CSI-RS).

In one embodiment, the first reference signal set comprises a Phase Tracking Reference Signal (PT-RS).

In one embodiment, the first reference signal set comprises a DeModulation Reference Signal (DMRS).

In one embodiment, the first measurement configuration group comprises multiple measurement configuration sub-groups, and the first measurement configuration sub-group is one of the multiple measurement configuration sub-groups.

In one embodiment, there at least exists one of the multiple measurement configuration sub-group being a unicast upper layer signaling.

In one embodiment, the first report information group comprises multiple report information sub-groups, and the multiple report information sub-groups respectively correspond to the multiple measurement configuration sub-groups.

In one embodiment, the first node is in a same RRC mode when receiving the first measurement configuration sub-group and performing a first channel measurement on a first reference signal set.

In one embodiment, the first node is in different RRC modes when receiving the first measurement configuration sub-group and performing a first channel measurement on a first reference signal set.

In one embodiment, the first node is in a same RRC mode when receiving the first measurement configuration group and receiving the first report configuration group.

In one embodiment, the first node is in different RRC modes when receiving the first measurement configuration group and receiving the first report configuration group.

In one embodiment, the first node is in an RRC idle mode.

In one embodiment, the first measurement configuration group comprises N measurement item(s), wherein N is a positive integer.

In one embodiment, each the measurement item indicates one reference signal in the first reference signal set.

In one embodiment, each the measurement item corresponds to an item in a measObjectToAddModList.

In one embodiment, each the measurement item corresponds to an item in a measIdToAddModList.

In one embodiment, the first report configuration group comprises M report configuration item(s), M being a positive integer.

In one embodiment, each the report configuration item correspond to an item in a reportConfigToAddModList.

In one embodiment, the first report message group measIdToAddModList comprises L report message item(s), and each the report message item corresponds to an item of a VarMeasReportList.

In one embodiment, L is a number of a result of the first channel measurement satisfying the first condition.

In one embodiment, the first measurement configuration sub-group comprises N1 measurement item(s), wherein N1 is a positive integer.

In one embodiment, each the measurement item comprised in the first measurement configuration sub-group corresponds to an item in a measIdToAddModList.

In one embodiment, the first channel measurement comprises a Reference Signal Receiving Power (RSRP) measurement performed on the first reference signal set.

In one embodiment, the first channel measurement comprises a Reference Signal Receiving Quality (RSRQ) measurement performed on the first reference signal set.

In one embodiment, the first channel measurement comprises a Received Signal Strength Indicator (RSSI) measurement performed on the first reference signal set.

In one embodiment, the first channel measurement comprises a Signal Noise Ratio (SNR) measurement performed on the first reference signal set.

In one embodiment, the first channel measurement comprises a hypothetical measurement performed on the first reference signal set.

In one embodiment, the hypothetical measurement comprises inferring a Block Error Rate (BLER) of a second channel based on a measurement performed on the first reference signal set.

In one embodiment, the hypothetical measurement comprises inferring a BLER of a second bearer based on a measurement performed on the first reference signal set.

In one embodiment, the second channel comprises a physical layer channel.

In one embodiment, the second channel comprises a transport layer channel.

In one embodiment, the second channel comprises a logical channel.

In one embodiment, the second channel comprises an MCH channel.

In one embodiment, the second channel comprises an MCCH channel.

In one embodiment, the second channel comprises an MTCH channel.

In one embodiment, the second bearer comprises a radio bearer.

In one embodiment, the second bearer comprises a radio access bearer.

In one embodiment, the second bearer comprises a cable bearer.

In one embodiment, the second bearer comprises an Internet Protocol (IP) bearer.

In one embodiment, the second bearer comprises a unicast bearer.

In one embodiment, the second bearer comprises a groupcast bearer.

In one embodiment, the second bearer comprises a broadcast bearer.

In one embodiment, the second channel comprises a Physical Downlink Control Channel (PDCCH) channel.

In one embodiment, the second channel comprises a PDSCH.

In one embodiment, the second channel comprises a PBCH.

In one embodiment, the according to a measurement performed on the first reference signal set comprises a measurement performed on an RSRP.

In one embodiment, the according to a measurement performed on the first reference signal set comprises a measurement performed on an RSRQ.

In one embodiment, the according to a measurement performed on the first reference signal set comprises a measurement performed on an RSSI.

In one embodiment, the according to a measurement performed on the first reference signal set comprises a measurement performed on an SNR.

In one embodiment, the first condition comprises a periodic triggering.

In one embodiment, the periodic triggering includes: for a current time T, when the first condition is satisfied at time T, T+T0 is also assumed as satisfying the first condition, where T0 is the periodically triggered period, T0 being a real number greater than 0.

In one embodiment, the periodic triggering includes: a time when the first condition is received is assumed as a start time of the periodically triggered period.

In one embodiment, the periodic triggering includes: the first report configuration group indicates a start time of the periodically triggered period.

In one embodiment, the periodic triggering includes: for a current time T, when the first condition is satisfied at time T, time within [T+T0,T+T1) can also be assumed as satisfying the first condition, T1 being a real number greater than 0.

In one embodiment, the first condition comprises an event triggering.

In one embodiment, the event triggering includes: a serving cell is better than a first absolute threshold.

In one embodiment, the event triggering includes: a serving cell is worse than a first absolute threshold.

In one embodiment, the event triggering includes: a neighbor cell exceeds a Primary Cell (PCell)/Primary Secondary Cell (PSCell) by a first offset.

In one embodiment, the event triggering includes: a neighbor cell is better than a first absolute threshold.

In one embodiment, the event triggering includes: a PCell/PSCell is worse than a first absolute threshold and a neighbor cell/Scell is better than a second absolute threshold.

In one embodiment, the event triggering includes: a neighbor cell is a first offset better than an SCell.

In one embodiment, a unit for measurement of the first absolute threshold comprises dB.

In one embodiment, a unit for measurement of the first absolute threshold comprises dBm.

In one embodiment, the first absolute threshold comprises -110 dBm.

In one embodiment, the first absolute threshold comprises -1 dB.

In one embodiment, a unit for measurement of the second absolute threshold comprises dB.

In one embodiment, a unit for measurement of the second absolute threshold comprises dBm.

In one embodiment, the second absolute threshold comprises -110 dBm.

In one embodiment, the second absolute threshold comprises -1 dB.

In one embodiment, the first offset comprises -3 dB.

In one embodiment, the first offset comprises 3 dB.

In one embodiment, the event triggering includes: a measurement result of a reference signal from a serving cell in the first reference signal set is better than the first absolute threshold.

In one embodiment, the event triggering includes: a measurement result of a reference signal from a serving cell in the first reference signal set is worse than the first absolute threshold.

In one embodiment, the event triggering includes: a measurement result of a reference signal from a neighbor cell in the first reference signal set exceeds a measurement result of a reference signal from a PCell or a PSCell in the first reference signal set by an offset.

In one embodiment, the event triggering includes: a measurement result of a reference signal from a neighbor cell in the first reference signal set is better than the first absolute threshold.

In one embodiment, the event triggering includes: a measurement result of a reference signal from a PCell or a PSCell in the first reference signal set is worse than the first absolute threshold and a measurement result of a reference signal from a neighbor cell or an SCell in the first reference signal set is better than the second absolute threshold.

In one embodiment, the event triggering includes: a measurement result of a reference signal from a neighbor cell in the first reference signal set is one offset better than a measurement result of a reference signal from an SCell in the first reference signal set.

In one embodiment, the event triggering includes: a measurement result of a reference signal corresponding to a serving cell in the first reference signal set is better than the first absolute threshold.

In one embodiment, the event triggering includes: a measurement result of a reference signal corresponding to a serving cell in the first reference signal set is worse than the first absolute threshold.

In one embodiment, the event triggering includes: a measurement result of a reference signal corresponding to a neighbor cell identity in the first reference signal set exceeds a measurement result of a reference signal corresponding to a PCell identity or a PSCell identity in the first reference signal set by an offset.

In one embodiment, the event triggering includes: a measurement result of a reference signal corresponding to a neighbor cell in the first reference signal set is better than the first absolute threshold.

In one embodiment, the event triggering includes: a measurement result of a reference signal corresponding to a PCell identity or a PSCell identity in the first reference signal set is worse than the first absolute threshold and a measurement result of a reference signal corresponding to a neighbor cell identity or an SCell identity in the first reference signal set is better than the second absolute threshold.

In one embodiment, the event triggering includes: a measurement result of a reference signal corresponding to a neighbor cell identity in the first reference signal set is one offset better than a measurement result of a reference signal corresponding to an SCell identity in the first reference signal set.

In one embodiment, the first measurement configuration sub-group indicates each reference signal in the first reference signal set and its corresponding cell identity.

In one embodiment, the cell ID comprises a serving cell ID.

In one embodiment, the cell ID comprises a PCell ID.

In one embodiment, the cell ID comprises a PSCell ID.

In one embodiment, the cell ID comprises an SCell ID.

In one embodiment, the cell ID comprises a neighbor cell ID.

In one embodiment, the first condition comprises a first timer expiration.

In one embodiment, the first measurement configuration sub-group configures the first timer.

In one embodiment, the event triggering includes: a BLER determined by the hypothetical measurement is better than a first threshold.

In one embodiment, the event triggering includes: a BLER determined by the hypothetical measurement is worse than a first threshold.

In one embodiment, the first threshold in the phrase that a BLER determined by the hypothetical measurement is better than a first threshold comprises 0.1.

In one embodiment, the first threshold in the phrase that a BLER determined by the hypothetical measurement is better than a first threshold comprises 0.01.

In one embodiment, the first threshold in the phrase that a BLER determined by the hypothetical measurement is worse than a first threshold comprises 0.1.

In one embodiment, the first threshold in the phrase that a BLER determined by the hypothetical measurement is worse than a first threshold comprises 0.01.

In one embodiment, a result of the first channel measurement comprises an RSRP value obtained by the first channel measurement performed by the first reference signal set.

In one embodiment, a result of the first channel measurement comprises an RSRQ value obtained by the first channel measurement performed by the first reference signal set.

In one embodiment, a result of the first channel measurement comprises an RSSI value obtained by the first channel measurement performed by the first reference signal set.

In one embodiment, a result of the first channel measurement comprises an SNR value obtained by the first channel measurement performed by the first reference signal set.

In one embodiment, a result of the first channel measurement comprises a BLER value obtained by the first channel measurement performed by the first reference signal set.

In one embodiment, the first report information group is transmitted through a PUSCH.

In one embodiment, the first report information group is transmitted through a Physical Uplink Control Channel (PUCCH).

In one embodiment, the first report information group comprises MeasResults.

In one embodiment, the first report information group comprises MeasResultEUTRA.

In one embodiment, the first report information group comprises MeasResultNR.

In one embodiment, the first report information group is transmitted through MCGFailureInformarion.

In one embodiment, the first report information group is transmitted through SCGFailureInformation.

In one embodiment, the first report information group is transmitted through UEAssistanceInformation.

In one embodiment, the first report information group is transmitted through a RRCEarlyDataRequest.

In one embodiment, the first report information group is transmitted through a UEInformationResponse.

In one embodiment, the first measurement configuration group comprises a parameter used for processing a measurement result.

In one embodiment, the parameter used for processing a measurement result comprised in the first measurement configuration group is used for processing a result of the first channel measurement.

In one embodiment, the parameter used for processing a measurement result comprised in the first measurement configuration group is used for processing a result of the second channel measurement.

In one embodiment, the parameter used for processing a measurement result comprises a rolloff coefficient.

In one embodiment, the parameter used for processing a measurement result comprises a smoothing coefficient.

In one embodiment, the parameter used for processing a measurement result comprises a mathematical transformation coefficient.

In one embodiment, the mathematical transform coefficient comprises a Fast Fourier transform (FFT) coefficient.

In one embodiment, the mathematical transform coefficient comprises a Discrete Cosine Transform (DCT) coefficient.

In one embodiment, the mathematical transform coefficient comprises a hash coefficient.

In one embodiment, the mathematical transform coefficient comprises a codebook coefficient.

In one embodiment, the first channel measurement on the first reference signal set is performed by the first node in a first time window; the second channel measurement on the second reference signal set is performed by the first node in a second time window.

In one embodiment, the first time window and the second time window are orthogonal in time domain.

In one embodiment, the first time window and the second time window are independent in time domain.

In one embodiment, the first node is in a Discontinuous Reception (DRX) state in a first time window, and the first node is in an active state in a second time window.

In one embodiment, the first node is in a DRX state in a second time window, and the first node is in an active state in a first time window.

In one embodiment, the first node is in a single-transmitting state in a second time window, and the first node is in a single-receiving state in a first time window.

In one embodiment, the first node is in a single-transmitting state in a first time window, and the first node is in a single-receiving state in a second time window.

In one embodiment, the first time window is related to receiving non-unicast data service, and the second time window is related to receiving unicast data service.

In one embodiment, the first node receives non-unicast data service in the first time window.

In one embodiment, the first node receives unicast data service in the second time window.

In one embodiment, the first node receives V2X services in the first time window.

In one embodiment, the first node receives Uu interface services in the second time window.

In one embodiment, the first node is in an RRC disconnected mode in the first time window.

In one embodiment, the first node is in an RRC connected mode in the second time window.

In one embodiment, a transmission delay from the second reference signal set to the first node is less than a first threshold.

In one embodiment, a transmission delay from the first reference signal set to the first node is not less than the first threshold.

In one embodiment, a transmission delay from the second reference signal set to the first node is less than a first threshold; and a transmission delay from the first reference signal set to the first node is not less than the first threshold.

In one embodiment, the first threshold is one of multiple candidate thresholds.

In one embodiment, a transmission delay from the second reference signal set to the first node is less than a minimum one of all candidate thresholds of the first threshold.

In one embodiment, a transmission delay from the first reference signal set to the first node is greater than or equal to a minimum one of all candidate thresholds of the first threshold.

In one embodiment, the first threshold is greater than a first cosmic velocity.

In one embodiment, the first threshold is greater than or equal to a minimum time delay from the first reference signal to the earth’s surface.

In one embodiment, a candidate threshold of the first threshold is greater than or equal to a slot.

In one embodiment, a candidate threshold of the first threshold is greater than or equal to a subframe.

In one embodiment, a candidate threshold of the first threshold is greater than or equal to 2 ms.

In one embodiment, a transmitter of the first reference signal set is an NTN satellite.

In one embodiment, a transmitter of the first reference signal set is an NTN node.

In one embodiment, a radio-frequency (RF) transmitter of the first reference signal set is an NTN satellite.

In one embodiment, a transmitter of the first reference signal set is a TN node.

In one embodiment, an RF transmitter of the first reference signal set is a TN node.

### Embodiment 2

Embodiment 2 illustrates a schematic diagram of a network architecture according to the present disclosure, as shown in FIG. 2.

FIG. 2 illustrates a network architecture 200 of 5G NR, Long-Term Evolution (LTE) and Long-Term Evolution Advanced (LTE-A) systems. The 5G NR or LTE network architecture 200 may be called a 5G System(5GS)/Evolved Packet System (EPS) 200 or other appropriate terms. The 5GS/EPS 200 may comprise one or more UEs 201, an NG-RAN 202, a 5G Core Network/Evolved Packet Core (5GC/EPC) 210, a Home Subscriber Server (HSS)/Unified Data Management (UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will readily understand that various concepts presented throughout the present disclosure can be extended to networks providing circuit switching services or other cellular networks. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5GC/EPC 210 for the UE 201. Examples of the UE 201 include cellular phones, smart phones, Session Initiation Protocol (SIP) phones, laptop computers, Personal Digital Assistant (PDA), satellite Radios, non-terrestrial base station communications, Satellite Mobile Communications, Global Positioning Systems (GPS), multimedia devices, video devices, digital audio players (for example, MP3 players), cameras, game consoles, unmanned aerial vehicles (UAV), aircrafts, narrow-band Internet of Things (loT) devices, machine-type communication devices, land vehicles, automobiles, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the 5GC/EPC 210 via an S1/NG interface. The 5GC/EPC 210 comprises a Mobility Management Entity (MME)/ Authentication Management Field (AMF)/ Session Management Function (SMF) 211, other MMEs/ AMFs/ SMFs 214, a Service Gateway (S-GW)/ User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user IP packets are transmitted through the S-GW/UPF 212, the S-GW/UPF 212 is connected to the P-GW/UPF 213. The P-GW provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the UE 201 corresponds to the first node in the present disclosure.

In one embodiment, the UE 201 supports NTN communications.

In one embodiment, the UE 201 supports communications within networks with large delay difference.

In one embodiment, the UE 201 supports V2X transmission.

In one embodiment, the UE 201 supports MBS transmission.

In one embodiment, the UE 201 supports MBMS transmission.

In one embodiment, the gNB 203 corresponds to the second node in the present disclosure.

In one embodiment, the gNB 203 supports communications within NTN.

In one embodiment, the gNB 203 supports communications within networks with large delay difference.

In one embodiment, the gNB 203 supports V2X transmission.

In one embodiment, the gNB 203 supports MBS transmission.

In one embodiment, the gNB 203 supports MBMS transmission.

### Embodiment 3

Embodiment 3 illustrates a schematic diagram of an example of a radio protocol architecture of a user plane and a control plane according to one embodiment of the present disclosure, as shown in FIG. 3. FIG. 3 is a schematic diagram illustrating an embodiment of a radio protocol architecture of a user plane 350 and a control plane 300. In FIG. 3, the radio protocol architecture for a first node (UE, gNB or a satellite or an aircraft in NTN) and a second node (gNB, UE or a satellite or an aircraft in NTN), or between two UEs is represented by three layers, which are a layer 1, a layer 2 and a layer 3, respectively. The layer 1 (L1) is the lowest layer and performs signal processing functions of various PHY layers. The L1 is called PHY 301 in the present disclosure. The layer 2 (L2) 305 is above the PHY 301, and is in charge of a link between a first node and a second node, as well as two UEs via the PHY 301. L2 305 comprises a Medium Access Control (MAC) sublayer 302, an RLC sublayer 303 and a Packet Data Convergence Protocol (PDCP) sublayer 304. All the three sublayers terminate at the second node. The PDCP sublayer 304 provides multiplexing among variable radio bearers and logical channels. The PDCP sublayer 304 provides security by encrypting a packet and provides support for a first node handover between second nodes. The RLC sublayer 303 provides segmentation and reassembling of a higher-layer packet, retransmission of a missing packet, and reordering of a data packet so as to compensate the disordered receiving caused by HARQ. The MAC sublayer 302 provides multiplexing between a logical channel and a transport channel. The MAC sublayer 302 is also responsible for allocating between first nodes various radio resources (i.e., resource block) in a cell. The MAC sublayer 302 is also in charge of HARQ operation. The Radio Resource Control (RRC) sublayer 306 in layer 3(L3) of the control plane 300 is responsible for acquiring radio resources (i.e., radio bearer) and configuring the lower layer with an RRC signaling between a second node and a first node. The radio protocol architecture of the user plane 350 comprises layer 1 (L1) and layer 2 (L2). In the user plane 350, the radio protocol architecture for the first node and the second node is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and DRB to support the diversity of service. Although not described in FIG. 3, the UE may comprise several higher layers above the L2 305, such as a network layer (i.e., IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present disclosure.

In one embodiment, the radio protocol architecture in FIG. 3 is applicable to the second node in the present disclosure.

In one embodiment, the first signaling in the present disclosure is generated by the PHY 301 or MAC 302 or RRC 306.

In one embodiment, the first report in the present disclosure is generated by the MAC 302 or RRC 306 or PDCP 304 or RLC 303.

In one embodiment, the first service in the present disclosure is generated by the SDAP 356 or PDCP 354 or layers or application layers above the L2 layer 355.

In one embodiment, the second signaling in the present disclosure is generated by the PHY 301 or MAC 302 or RRC 306.

In one embodiment, the first information in the present disclosure is generated by the PHY 301 or MAC 302 or RRC 306.

In one embodiment, the first data set in the present disclosure is generated by the SDAP 356 or PDCP 354 or layers or application layers above the L2 layer 355.

In one embodiment, the first measurement configuration group in the present disclosure is generated by the MAC 302 or RRC 306.

In one embodiment, the first measurement configuration sub-group in the present disclosure is generated by the MAC 302 or RRC 306.

In one embodiment, the second measurement configuration sub-group in the present disclosure is generated by the MAC 302 or RRC 306.

In one embodiment, the first report configuration group in the present disclosure is generated by the MAC 302 or RRC 306.

In one embodiment, the first report configuration sub-group in the present disclosure is generated by the MAC 302 or RRC 306.

In one embodiment, the second report configuration sub-group in the present disclosure is generated by the MAC 302 or RRC 306.

In one embodiment, the first report information group in the present disclosure is generated by the MAC 302 or RRC 306.

In one embodiment, the first reference signal set in the present disclosure is generated by the PHY 301 or MAC 302 or RRC 306.

In one embodiment, the first reference signal set in the present disclosure is generated by the PHY 301 or MAC 302 or RRC 306.

In one embodiment, the second reference signal set in the present disclosure is generated by the PHY 301 or MAC 302 or RRC 306.

In one embodiment, the candidate measurement configuration sub-group in the present disclosure is generated by the MAC 302 or RRC 306.

In one embodiment, the Q1 identity(identities) in the present disclosure is(are) generated by the MAC 302 or RRC 306.

In one embodiment, the first time information in the present disclosure is generated by the MAC 302 or RRC 306.

In one embodiment, the first signal in the present disclosure is generated by the PHY 301 or MAC 302 or RRC 306.

In one embodiment, the second signal in the present disclosure is generated by the PHY 301 or MAC 302 or RRC 306.

### Embodiment 4

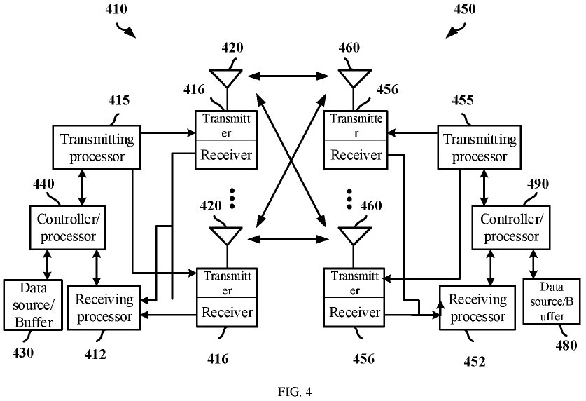

Embodiment 4 illustrates a schematic diagram of a first communication device and a second communication device in the present disclosure, as shown in FIG. 4. FIG. 4 is a block diagram of a first communication device 450 in communication with a second communication device 410 in an access network.

The first communication device 450 comprises a controller/ processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/ processor 475, a memory 476, a receiving processor 470, a transmitting processor 416, a multi-antenna receiving processor 472, a multi-antenna transmitting processor 471, a transmitter/ receiver 418 and an antenna 420.

In a transmission from the second communication device 410 to the first communication device 450, at the first communication device 410, a higher layer packet from the core network is provided to a controller/ processor 475. The controller/processor 475 provides a function of the L2 layer. In the transmission from the second communication device 410 to the first communication device 450, the controller/ processor 475 provides header compression, encryption, packet segmentation and reordering, and multiplexing between a logical channel and a transport channel, and radio resources allocation for the first communication device 450 based on various priorities. The controller/ processor 475 is also responsible for retransmission of a missing packet and a signaling to the first communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 410, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the second communication device 410 to the first communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the first communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the second communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In the transmission from the second communication device 410 to the second communication device 450, the controller/ processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing.

In a transmission from the first communication device 450 to the second communication device 410, at the second communication device 450, the data source 467 is configured to provide a higher-layer packet to the controller/processor 459. The data source 467 represents all protocol layers above the L2 layer. Similar to a transmitting function of the second communication device 410 described in the transmission from the second communication device 410 to the first communication device 450, the controller/processor 459 performs header compression, encryption, packet segmentation and reordering, and multiplexing between a logical channel and a transport channel based on radio resources allocation so as to provide the L2 layer functions used for the user plane and the control plane. The controller/processor 459 is also responsible for retransmission of a missing packet, and a signaling to the second communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the first communication device 450 to the second communication device 410, the function at the second communication device 410 is similar to the receiving function at the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the first communication device 450 to the second communication device 410,the controller/processor 475 provides de-multiplexing between a transport channel and a logical channel, packet reassembling, decryption, header decompression, control signal processing so as to recover a higher-layer packet from the UE 450. The higher-layer packet coming from the controller/processor 475 may be provided to the core network.

In one embodiment, the first communication device 450 comprises at least one processor and at least one memory. The at least one memory comprises computer program codes; the at least one memory and the computer program codes are configured to be used in collaboration with the at least one processor. The UE 450 at least: receives a first service through a first radio bearer; and receives a first signaling, the first signaling indicating establishing a second radio bearer for the first service; transmits a first report; and receives the first service through at least a latter of the first radio bearer and the second radio bearer; herein, when a first condition is satisfied, the first report is transmitted; the first condition comprises that a reception of the first service is modified from the first radio bearer to the second radio bearer; a bearer type of the first radio bearer is different from a bearer type of the second radio bearer, and the bearer type comprises a non-unicast bearer and a unicast bearer; the first report is used for indicating an SDU related to the first service and received through the first radio bearer, and the first report is upper layer control information.

In one embodiment, the first communication device 450 comprises a memory that stores a computer readable instruction program. The computer readable instruction program generates an action when executed by at least one processor. The action includes: receiving a first service through a first radio bearer; and receiving a first signaling, the first signaling indicating establishing a second radio bearer for the first service; transmitting a first report; and receiving the first service through at least a latter of the first radio bearer and the second radio bearer; herein, when a first condition is satisfied, the first report is transmitted; the first condition comprises that a reception of the first service is modified from the first radio bearer to the second radio bearer; a bearer type of the first radio bearer is different from a bearer type of the second radio bearer, and the bearer type comprises a non-unicast bearer and a unicast bearer; the first report is used for indicating an SDU related to the first service and received through the first radio bearer, and the first report is upper layer control information.

In one embodiment, the second communication device 410 comprises at least one processor and at least one memory. The at least one memory comprises computer program codes; the at least one memory and the computer program codes are configured to be used in collaboration with the at least one processor. The second communication device 410 at least transmits a first signaling, the first signaling indicating a second radio bearer establishing a first service; the first service is transmitted through a first radio bearer; receives a first report; and transmits the first service through at least a latter of the first radio bearer and the second radio bearer; herein, when a first condition is satisfied, the receiver of the first signaling transmits the first report; the first condition comprises that a reception of the first service is modified from the first radio bearer to the second radio bearer; a bearer type of the first radio bearer is different from a bearer type of the second radio bearer, and the bearer type comprises a non-unicast bearer and a unicast bearer; the first report is used for indicating an SDU related to the first service and received through the first radio bearer, and the first report is upper layer control information.

In one embodiment, the second communication device 410 comprises a memory that stores a computer readable instruction program. The computer readable instruction program generates an action when executed by at least one processor. The action includes: transmitting a first signaling, the first signaling indicating a second radio bearer establishing a first service; the first service being transmitted through a first radio bearer; receiving a first report; and transmitting the first service through at least a latter of the first radio bearer and the second radio bearer; herein, when a first condition is satisfied, the receiver of the first signaling transmits the first report; the first condition comprises that a reception of the first service is modified from the first radio bearer to the second radio bearer; a bearer type of the first radio bearer is different from a bearer type of the second radio bearer, and the bearer type comprises a non-unicast bearer and a unicast bearer; the first report is used for indicating an SDU related to the first service and received through the first radio bearer, and the first report is upper layer control information.

In one embodiment, the first communication device 450 corresponds to a first node in the present disclosure.

In one embodiment, the second communication device 410 corresponds to a second node in the present disclosure.

In one embodiment, the first communication device 450 is a UE.

In one embodiment, the first communication device 450 is a vehicle terminal.

In one embodiment, the second communication device 410 is a base station.

In one embodiment, the second communication device 410 is a UE.

In one embodiment, the second communication device 410 is a satellite.

In one embodiment, the receiver 456 (including the antenna 460), the receiving processor 452 and the controller/processor 490 are used to receive the first signaling in the present disclosure.

In one embodiment, the receiver 456 (including the antenna 460), the receiving processor 452 and the controller/processor 490 are used to receive the second signaling in the present disclosure.

In one embodiment, the receiver 456 (including the antenna 460), the receiving processor 452 and the controller/processor 490 are used to receive the first data set in the present disclosure.

In one embodiment, the receiver 456 (including the antenna 460), the receiving processor 452 and the controller/processor 490 are used to receive the first service in the present disclosure.

In one embodiment, the transmitter 456 (including the antenna 460), the transmitting processor 455 and the controller/processor 490 are to transmit the first information in the present disclosure.

In one embodiment, the transmitter 456 (including the antenna 460), the transmitting processor 455 and the controller/processor 490 are to transmit the first report in the present disclosure.

In one embodiment, the transmitter 416 (including the antenna 420), the transmitting processor 412 and the controller/processor 440 are used to transmit the first signaling in the present disclosure.

In one embodiment, the transmitter 416 (including the antenna 420), the transmitting processor 412 and the controller/processor 440 are used to transmit the second signaling in the present disclosure.

In one embodiment, the transmitter 416 (including the antenna 420), the transmitting processor 412 and the controller/processor 440 are used to transmit the first service in the present disclosure.

In one embodiment, the transmitter 416 (including the antenna 420), the transmitting processor 412 and the controller/processor 440 are used to transmit the first data set in the present disclosure.

In one embodiment, the receiver 416 (including the antenna 420), the receiving processor 412 and the controller/processor 440 are used to receive the first report in the present disclosure.

In one embodiment, the receiver 416 (including the antenna 420), the receiving processor 412 and the controller/processor 440 are used to receive the first information in the present disclosure.

In one embodiment, the first communication device 450 comprises at least one processor and at least one memory. The at least one memory comprises computer program codes; the at least one memory and the computer program codes are configured to be used in collaboration with the at least one processor, the first communication device 450 at least receives a first signaling; and transmits a first signal; herein, the first signaling is used for indicating a first identity and a second identity, and both the first identity and the second identity are used for determining the first node; the first signal carries a target identity, the target identity is one of the first identity or the second identity; when the target identity is the first identity, the first signal carries a first message; and when the target identity is the second identity, the first signal carries a second message; a first logical channel is used for bearing the first message, a second logical channel is used for bearing the second message, the first logical channel is different from the second logical channel, and the first message and the second message come from an access layer; the first signal carries a first data block, and the first data block comes from a non-access layer; both a magnitude of the first data block and a magnitude of the first signal are used for determining the target identity; the first node is in non-active state of a radio resource control when transmitting the first signal.

In one embodiment, the first communication device 450 comprises a memory that stores a computer readable instruction program. The computer readable instruction program generates an action when executed by at least one processor. The action includes: receiving a first signaling; and transmitting a first signal; herein, the first signaling is used for indicating a first identity and a second identity, and both the first identity and the second identity are used for determining the first node; the first signal carries a target identity, the target identity is one of the first identity or the second identity; when the target identity is the first identity, the first signal carries a first message; when the target identity is the second identity, the first signal carries a second message; a first logical channel is used for bearing the first message, a second logical channel is used for bearing the second message, the first logical channel is different from the second logical channel, and the first message and the second message come from an access layer; the first signal carries a first data block, and the first data block comes from a non-access layer; both a magnitude of the first data block and a magnitude of the first signal are used for determining the target identity; and the first node is in a non-active state of radio resource control when transmitting the first signal.

In one embodiment, the second communication device 410 comprises at least one processor and at least one memory. The at least one memory comprises computer program codes; the at least one memory and the computer program codes are configured to be used in collaboration with the at least one processor. The second communication device 410 at least transmits a first signaling; and receives a first signal; herein, the first signaling is used for indicating a first identity and a second identity, and both the first identity and the second identity are used for determining a transmitter of the first signal; the first signal carries a target identity, the target identity is one of the first identity or the second identity; when the target identity is the first identity, the first signal carries a first message; and when the target identity is the second identity, the first signal carries a second message; a first logical channel is used for bearing the first message, a second logical channel is used for bearing the second message, the first logical channel is different from the second logical channel, and the first message and the second message come from an access layer; the first signal carries a first data block, and the first data block comes from a non-access layer; both a magnitude of the first data block and a magnitude of the first signal are used for determining the target identity; the transmitter of the first signal is in a non-active state of radio resource control when transmitting the first signal.

In one embodiment, the second communication device 410 comprises a memory that stores a computer readable instruction program. The computer readable instruction program generates an action when executed by at least one processor. The action includes: transmitting a first signaling; and receiving a first signal; herein, the first signaling is used for indicating a first identity and a second identity, and both the first identity and the second identity are used for determining a transmitter of the first signal; the first signal carries a target identity, the target identity is one of the first identity or the second identity; when the target identity is the first identity, the first signal carries a first message; and when the target identity is the second identity, the first signal carries a second message; a first logical channel is used for bearing the first message, a second logical channel is used for bearing the second message, the first logical channel is different from the second logical channel, and the first message and the second message come from an access layer; the first signal carries a first data block, and the first data block comes from a non-access layer; both a magnitude of the first data block and a magnitude of the first signal are used for determining the target identity; the transmitter of the first signal is in a non-active state of radio resource control when transmitting the first signal.

In one embodiment, the first communication device 450 corresponds to a first node in the present disclosure.

In one embodiment, the second communication device 410 corresponds to a second node in the present disclosure.

In one embodiment, the first communication device 450 is a UE.

In one embodiment, the first communication device 450 is a vehicle terminal.

In one embodiment, the second communication device 410 is a base station.

In one embodiment, the second communication device 410 is a UE.

In one embodiment, the second communication device 410 is a satellite.

In one embodiment, the receiver 456 (including the antenna 460), the receiving processor 452 and the controller/processor 490 are used to receive the first measurement configuration group in the present disclosure.

In one embodiment, the receiver 456 (including the antenna 460), the receiving processor 452 and the controller/processor 490 are used to receive the first report configuration group in the present disclosure.

In one embodiment, the receiver 456 (including the antenna 460), the receiving processor 452 and the controller/processor 490 are used to receive the first reference signal in the present disclosure.

In one embodiment, the receiver 456 (including the antenna 460), the receiving processor 452 and the controller/processor 490 are used to receive the second reference signal in the present disclosure.

In one embodiment, the receiver 456 (including the antenna 460), the receiving processor 452 and the controller/processor 490 are used to receive the candidate measurement configuration sub-group in the present disclosure.

In one embodiment, the receiver 456 (including the antenna 460), the receiving processor 452 and the controller/processor 490 are used to receive the second signal in the present disclosure.

In one embodiment, the transmitter 456 (including the antenna 460), the transmitting processor 455 and the controller/processor 490 are to transmit the first signal in the present disclosure.

In one embodiment, the transmitter 456 (including the antenna 460), the transmitting processor 455 and the controller/processor 490 are to transmit the first report information group in the present disclosure.

In one embodiment, the transmitter 456 (including the antenna 460), the transmitting processor 455 and the controller/processor 490 are to transmit the Q1 identity(identities) in the present disclosure.

In one embodiment, the transmitter 416 (including the antenna 420), the transmitting processor 412 and the controller/processor 440 are used to transmit the first measurement configuration group in the present disclosure.

In one embodiment, the transmitter 416 (including the antenna 420), the transmitting processor 412 and the controller/processor 440 are used to transmit the first report configuration group in the present disclosure.

In one embodiment, the transmitter 416 (including the antenna 420), the transmitting processor 412 and the controller/processor 440 are used to transmit the first reference signal set in the present disclosure.

In one embodiment, the transmitter 416 (including the antenna 420), the transmitting processor 412 and the controller/processor 440 are used to transmit the second reference signal set in the present disclosure.

In one embodiment, the transmitter 416 (including the antenna 420), the transmitting processor 412 and the controller/processor 440 are used to transmit the candidate measurement configuration sub-group in the present disclosure.

In one embodiment, the transmitter 416 (including the antenna 420), the transmitting processor 412 and the controller/processor 440 are used to transmit the second signal in the present disclosure.

In one embodiment, the receiver 416 (including the antenna 420), the receiving processor 412 and the controller/processor 440 are used to receive the first signal in the present disclosure.

In one embodiment, the receiver 416 (including the antenna 420), the receiving processor 412 and the controller/processor 440 are used to receive the first report information group in the present disclosure.

In one embodiment, the receiver 416 (including the antenna 420), the receiving processor 412 and the controller/processor 440 are used to receive the Q1 identity(identities) in the present disclosure.

### Embodiment 5A

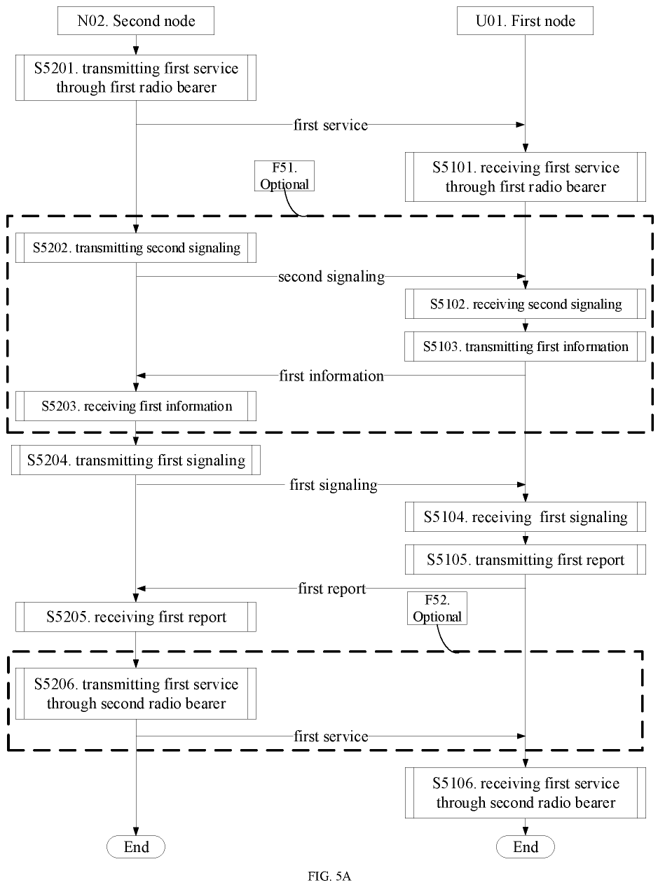

Embodiment 5A illustrates a flowchart of radio signal transmission according to one embodiment in the present disclosure, as shown in FIG. 5A. In FIG. 5A, U01 corresponds to a first node in the present disclosure, N02 corresponds to a second node in the present disclosure. It is particularly underlined that the order illustrated in the embodiment does not put constraints over sequences of signal transmissions and implementations and steps in F51 and F52 are optional.

The first node U01 receives a first service through a first radio bearer in step S5101; receives a second signaling in step S5102; transmits first information in step S5103; and receives a first signaling in step S5104, the first signaling indicates establishing a second radio bearer for the first service; transmits a first report in step S5105;and receives the first service through the second radio bearer in step S5106.

The second node N02 transmits the first service through the first radio bearer in step S5201; transmits the second signaling in step S5202; receives the first information in step S5203; transmits the first signaling in step S5204; receives the first report in step S5205; and transmits the first service through the second radio bearer in step S5206.

In Embodiment 5A, the first node U01 receives the first service through at least a latter of the first radio bearer and the second radio bearer; when a first condition is satisfied, the first node transmits the first report; the first condition comprises that a reception of the first service is modified from the first radio bearer to the second radio bearer; a bearer type of the first radio bearer is different from a bearer type of the second radio bearer, and the bearer type comprises a non-unicast bearer and a unicast bearer; the first report is used for indicating an SDU related to the first service and received through the first radio bearer, and the first report is upper layer control information.

In one embodiment, the first report is an RRC signaling, the first report comprises a first identity, the first identity is used for determining a PDCP SDU related to the first service and received after a first missing PDCP SDU through the first radio bearer.

In one embodiment, the first report is transmitted via an RRC signaling.

In one embodiment, the first identity is a field in the first report.

In one embodiment, the first identity comprises a Sequence Number (SN).

In one embodiment, the first identity comprises a PDCP SN.

In one embodiment, the first identity is related to a length of a downlink SN of a PDCP of the first radio bearer.

In one embodiment, the first identity comprises a Hyper Frame Number (HFN).

In one embodiment, the first identity comprises a COUNT.

In one embodiment, a state variable of a PDCP associated with the first radio bearer is used for determining the first identity.

In one embodiment, the phrase that the PDCP SDU related to the first service and received through the first radio bearer after a first missing PDCP SDU includes the following meaning: the first missing PDCP SDU is data of the first service.

In one embodiment, the phrase that the PDCP SDU related to the first service and received through the first radio bearer after a first missing PDCP SDU includes the following meaning: the first missing PDCP SDU is user-plane data of the first service.

In one embodiment, the phrase that the PDCP SDU related to the first service and received through the first radio bearer after a first missing PDCP SDU includes the following meaning: the first missing PDCP SDU belongs to a receive window of a PDCP associated with the first radio bearer.

In one embodiment, the phrase that the PDCP SDU related to the first service and received through the first radio bearer after a first missing PDCP SDU includes the following meaning: the first missing PDCP SDU is within a receive window of a PDCP associated with the first radio bearer.

In one embodiment, the phrase that the PDCP SDU related to the first service and received through the first radio bearer after a first missing PDCP SDU includes the following meaning: a COUNT value corresponding to the first missing PDCP SDU is determined as the first identity.

In one embodiment, the phrase that the PDCP SDU related to the first service and received through the first radio bearer after a first missing PDCP SDU includes the following meaning: a COUNT value corresponding to the first missing PDCP SDU and a fixed offset are determined as the first identity.

In one embodiment, the phrase that the PDCP SDU related to the first service and received through the first radio bearer after a first missing PDCP SDU includes the following meaning: a next value of a COUNT value corresponding to the first missing PDCP SDU is determined as the first identity.

In one embodiment, the phrase that the PDCP SDU related to the first service and received through the first radio bearer after a first missing PDCP SDU includes the following meaning: a PDCP SDU after a PDCP SDU with a largest COUNT value is assumed to be missing, and the first identity is a largest value of a COUNT value among all PDCP SDUs related to the first service and received through the first radio bearer.

In one embodiment, the phrase that the PDCP SDU related to the first service and received through the first radio bearer after a first missing PDCP SDU includes the following meaning: a PDCP SDU after a PDCP SDU with a largest COUNT value is assumed to be missing, and the first identity is a next value of a largest value of a COUNT value among all PDCP SDUs related to the first service and received through the first radio bearer.

In one embodiment, the first identity comprises an RX_DELIV.

In one embodiment, the first identity comprises an RX_NEXT.

In one embodiment, the first identity comprises an RX_REORD.

In one embodiment, the first report is an RRC signaling, the first report comprises a second identity, the second identity is used for determining a first time window, and the first time window is a time window related to the first service and corresponding to a last SDU received through the first radio bearer.

In one embodiment, a first missing PDCP SDU related to the first service and through the first radio bearer is a control signaling.

In one embodiment, a first missing PDCP SDU related to the first service and through the first radio bearer is an RRC signaling.

In one embodiment, a first missing PDCP SDU related to the first service and through the first radio bearer is an RRC signaling transmitted through a control logical channel related to the first service.

In one embodiment, the time window is determined by a Modification Period of a control channel related to the first service and transmitted through the first radio bearer.

In one embodiment, the time window is equal to a Modification Period of a control channel related to the first service and transmitted through the first radio bearer.

In one embodiment, the time window is determined by a Repetition Period of a control channel related to the first service and transmitted through the first radio bearer.

In one embodiment, the time window is equal to a Repetition Period of a control channel related to the first service and transmitted through the first radio bearer.

In one embodiment, the time window is equal to a Modification Period of a control channel related to the first service and transmitted through the first radio bearer plus a fixed time offset.

In one embodiment, the time window is equal to a Modification Period of a control channel related to the first service and transmitted through the first radio bearer plus a fixed time offset, and the fixed time offset is z ms, wherein z is a positive integer.

In one embodiment, the time window is determined by a Modification Period of a service channel related to the first service and transmitted through the first radio bearer.

In one embodiment, the time window is equal to a Modification Period of a service channel related to the first service and transmitted through the first radio bearer.

In one embodiment, the time window is determined by a Repetition Period of a service channel related to the first service and transmitted through the first radio bearer.

In one embodiment, the time window is equal to a Repetition Period of a service channel related to the first service and transmitted through the first radio bearer.

In one embodiment, the time window is equal to a Modification Period of a service channel related to the first service and transmitted through the first radio bearer plus a fixed time offset.

In one embodiment, the time window is equal to a Modification Period of a service channel related to the first service and transmitted through the first radio bearer plus a fixed time offset, and the fixed time offset is z ms, wherein z is a positive integer.

In one embodiment, the control channel related to the first service comprises an MCCH.

In one embodiment, the control channel related to the first service comprises an SC-MCCH.

In one embodiment, the service channel related to the first service comprises an MTCH.

In one embodiment, the service channel related to the first service comprises an SC-MTCH.

In one embodiment, the first identity comprises an identity of the first time window.

In one embodiment, an identity of the first time window comprises an ID of the first time window.

In one embodiment, an identity of the first time window comprises a TransactionIdentifier of the first time window.

In one embodiment, an identity of the first time window comprises an RRC-TransactionIdentifier of the first time window.

In one embodiment, an identity of the first time window comprises a System Frame Number (SFN) of the first time window.

In one embodiment, an identity of the first time window comprises a Hyper Frame Number (HFN) of the first time window.

In one embodiment, an identity of the first time window comprises a first SFN of the first time window.

In one embodiment, an identity of the first time window comprises a last SFN of the first time window.

In one embodiment, the phrase that the first time window is a time window corresponding to a last SDU related to the first service and received through the first radio bearer includes the following meaning: a last SDU related to the first service and received through the first radio bearer is an SDU transmitted through a control channel.

In one embodiment, the phrase that the first time window is a time window corresponding to a last SDU related to the first service and received through the first radio bearer includes the following meaning: a last SDU related to the first service and received through the first radio bearer is an SDU of an RRC signaling.

In one embodiment, the phrase that the first time window is a time window corresponding to a last SDU related to the first service and received through the first radio bearer includes the following meaning: a last SDU related to the first service and received through the first radio bearer is an SDU transmitted through an MCCH.

In one embodiment, the phrase that the first time window is a time window corresponding to a last SDU related to the first service and received through the first radio bearer includes the following meaning: a last SDU related to the first service and received through the first radio bearer is an SDU transmitted through an SC-MCCH.

In one embodiment, the phrase that the first time window is a time window corresponding to a last SDU related to the first service and received through the first radio bearer includes the following meaning: a time window to which the last SDU belongs is the first time window.

In one embodiment, the phrase that the first time window is a time window corresponding to a last SDU related to the first service and received through the first radio bearer includes the following meaning: the last SDU is transmitted within the first time window.

In one embodiment, the phrase that the first time window is a time window corresponding to a last SDU related to the first service and received through the first radio bearer includes the following meaning: the last SDU is received within the first time window.

In one embodiment, the phrase that the first time window is a time window corresponding to a last SDU related to the first service and received through the first radio bearer includes the following meaning: a time for transmitting the last SDU is equal to a start time of the first time window.

In one embodiment, the phrase that the first time window is a time window corresponding to a last SDU related to the first service and received through the first radio bearer includes the following meaning: a time for receiving the last SDU is equal to a start time of the first time window.

In one embodiment, the phrase that the first time window is a time window corresponding to a last SDU related to the first service and received through the first radio bearer includes the following meaning: a time for transmitting the last SDU is equal to an end time of the first time window.

In one embodiment, the phrase that the first time window is a time window corresponding to a last SDU related to the first service and received through the first radio bearer includes the following meaning: a time for receiving the last SDU is equal to an end time of the first time window.

In one embodiment, the first report is a PDCP status report, a first status variable group is a subset of a set consists of all status variables of a PDCP entity associated with the second radio bearer, and the first signaling indicates that a value of a status variable in the first status variable group is determined by a value of a status variable of a PDCP entity associated with the first radio bearer; the first node generates the first report according to a PDCP entity associated with the second radio bearer, and the first node transmits the first report through a radio bearer whose bearer type is unicast bearer in the first radio bearer and the second radio bearer.

In one embodiment, the first report is a PDCP Status Report.

In one embodiment, RadioBearerConfig is used for configuring the first radio bearer, and the first radio bearer is associated with a PDCP entity in the RadioBearerConfig.

In one embodiment, RadioBearerConfig is used for configuring the first radio bearer, and the first radio bearer is associated with a configuration of a PDCP entity in the RadioBearerConfig.

In one embodiment, RadioBearerConfig is used for configuring the first radio bearer, and the first radio bearer is associated with a configuration of a PDCP entity through a drb-Identity in the RadioBearerConfig.

In one embodiment, a serving cell of the first node U01 configures the first radio bearer and a PDCP entity associated with the first radio bearer via an RRC signaling.

In one embodiment, RadioBearerConfig is used for configuring the second radio bearer, and the first radio bearer is associated with a PDCP entity in the RadioBearerConfig.

In one embodiment, RadioBearerConfig is used for configuring the second radio bearer, and the first radio bearer is associated with a configuration of a PDCP entity in the RadioBearerConfig.

In one embodiment, RadioBearerConfig is used for configuring the second radio bearer, and the first radio bearer is associated with a configuration of a PDCP entity through a drb-Identity in the RadioBearerConfig.

In one embodiment, a serving cell of the first node U01 configures the second radio bearer and a PDCP entity associated with the first radio bearer via an RRC signaling.

In one embodiment, the first state variable group is a set of all state variables of a PDCP entity associated with the second radio bearer.

In one embodiment, the first state variable only comprises part of state variables in a set consists of all state variables of a PDCP entity associated with the second radio bearer.

In one embodiment, the first radio bearer employs Unacknowledged Mode (UM).

In one embodiment, the first radio bearer employs Acknowledged Mode (AM).

In one embodiment, the second radio bearer employs AM.

In one embodiment, the second radio bearer employs UM.

In one embodiment, the first radio bearer is a unicast bearer and employs UM; the second radio bearer is a unicast bearer and employs AM.

In one embodiment, the first radio bearer is a unicast bearer and employs UM; the second radio bearer is a unicast bearer and employs UM.

In one embodiment, the state variable of a PDCP entity associated with the second radio bearer is a non-negative integer.

In one embodiment, the state variable of a PDCP entity associated with the second radio bearer comprises a TX_NEXT.

In one embodiment, the state variable of a PDCP entity associated with the second radio bearer comprises an RX_NEXT.

In one embodiment, the state variable of a PDCP entity associated with the second radio bearer comprises an RX_DELIV.

In one embodiment, the state variable of a PDCP entity associated with the second radio bearer comprises an RX_REORD.

In one embodiment, the state variable of a PDCP entity associated with the second radio bearer comprises a COUNT.

In one embodiment, the state variable of a PDCP entity associated with the second radio bearer comprises an HFN.

In one embodiment, a pdcp-SN-SizeUL of a PDCP entity associated with the first radio bearer and a pdcp-SN-SizeUL of a PDCP entity associated with the second radio bearer are configured to be the same.

In one embodiment, a pdcp-SN-SizeUL of a PDCP entity associated with the first radio bearer and a pdcp-SN-SizeUL of a PDCP entity associated with the second radio bearer are configured to be different.

In one embodiment, a pdcp-SN-SizeDL of a PDCP entity associated with the first radio bearer and a pdcp-SN-SizeUL of a PDCP entity associated with the second radio bearer are configured to be the same.

In one embodiment, a pdcp-SN-SizeDL of a PDCP entity associated with the first radio bearer and a pdcp-SN-SizeUL of a PDCP entity associated with the second radio bearer are configured to be different.

In one embodiment, a discardTimer of a PDCP entity associated with the first radio bearer and a discardTimer of a PDCP entity associated with the second radio bearer are configured to be different.

In one embodiment, a t-Reordering of a PDCP entity associated with the first radio bearer and a t-Reordering of a PDCP entity associated with the second radio bearer are configured to be different.

In one embodiment, advantages that a parameter of a PDCP entity associated with the first radio bearer and a corresponding parameter of a PDCP entity associated with the second radio bearer are configured to be different include: bearing types of the first radio bearer and the second radio bearer are different, so that their functions are different, and different parameters are needed to be configured for them, which is conducive to realizing their functions.

In one embodiment, a value of a state variable in the first state variable group is determined by a value of a state variable with a same name of a PDCP entity associated with the first radio bearer.

In one embodiment, a value of a state variable in the first state variable group is determined by a value of a state variable corresponding to a PDCP entity associated with the first radio bearer.

In one embodiment, advantages that a parameter of a PDCP entity associated with the first radio bearer and a corresponding parameter of a PDCP entity associated with the second radio bearer are configured to be different include: when modes of the first radio bearer and the second radio bearer are different, that is, one employs an AM and the other employs a UM, in this case, a bearer employing the AM can support a certain degree of link recovery, therefore, longer SN is necessary to be employed, that is a pdcp-SN-SizeUL and a pdcp-SN-SizeDL, for the UM mode, since there is no need to recover an earlier transmitted packet, so there is no need for a long SN.

In one embodiment, advantages that a parameter of a PDCP entity associated with the first radio bearer and a corresponding parameter of a PDCP entity associated with the second radio bearer are configured to be different include: when modes of the first radio bearer and the second radio bearer are different, that is, one employs AM and the other employs UM, since the AM supports data recovery, therefore a longer buffer sorting can be employed to realize in sequence delivery; while the UM cannot recover data, so it’s better to support out of sequence delivery.

In one embodiment, a value of a state variable comprised in the first state variable of a PDCP entity associated with the second radio bearer is equal to a value of a state variable of a PDCP entity associated with the first radio bearer.

In one embodiment, an initial value of a state variable comprised in the first state variable group of a PDCP entity associated with the second radio bearer is configured as a value of a state variable of a PDCP entity associated with the first radio bearer.

In one embodiment, an initial value equal to a value of a state variable other than the first state variable group of a PDCP entity associated with the second radio bearer is configured as 0.

In one embodiment, the first state variable only comprises TX_NEXT.

In one embodiment, the first state variable only comprises a state variable other than TX _NEXT.

In one embodiment, the first state variable only comprises RX_NEXT and RX_DELIV.

In one embodiment, the first state variable only comprises RX_REORD.

In one embodiment, the first state variable only comprises RX_NEXT, RX_DELIV and RX_REORD.

In one embodiment, the first state variable only comprises COUNT.

In one embodiment, the first state variable only comprises RX_NEXT, RX_DELIV and COUNT.

In one embodiment, the first state variable only comprises RX_NEXT, RX_DELIV, RX_REORD and COUNT.

In one embodiment, if the second radio bearer is an AM and the first radio bearer is a UM, the first state variable group only comprises RX_NEXT and RX_DELIV.

In one embodiment, if the second radio bearer is an AM and the first radio bearer is a UM, the first state variable group only comprises RX_NEXT, RX_DELIV and COUNT.

In one embodiment, if the second radio bearer is an AM and the first radio bearer is a UM, the first state variable group only comprises RX_NEXT, RX_DELIV and RX_REORD.

In one embodiment, if the second radio bearer is an AM and the first radio bearer is a UM, the first state variable group only comprises RX_NEXT, RX_DELIV, RX_REORD and COUNT.

In one embodiment, if the second radio bearer is a UM and the first radio bearer is a UM, the first state variable group only comprises COUNT.

In one embodiment, a state variable comprised in the first state variable group is related to whether a mode of the second radio bearer is the same as a mode of the first radio bearer.

In one embodiment, when a pdcp-SN-SizeDL of a PDCP entity associated with the second radio bearer is less than a pdcp-SN-SizeDL of a PDCP entity associated with the first radio bearer, a value of a state variable belonging to the first state variable group of the PDCP entity associated with the second radio bearer is a truncated value of a value of a state variable corresponding to the PDCP entity associated with the first radio bearer.

In one subembodiment of the above embodiment, a truncated length of the truncated value is equal to a difference of a pdcp-SN-SizeDL of a PDCP entity associated with the first radio bearer and a pdcp-SN-SizeDL of a PDCP entity associated with the second radio bearer.

In one subembodiment of the above embodiment, truncation of the truncated value is low truncation.

In one subembodiment of the above embodiment, truncation of the truncated value is high truncation.

In one embodiment, when a pdcp-SN-SizeDL of a PDCP entity associated with the second radio bearer is less than a pdcp-SN-SizeDL of a PDCP entity associated with the first radio bearer, a value of an HFN part of a state variable belonging to the first state variable group of a PDCP entity associated with the second radio bearer is equal to a value of an HFN part of a state variable corresponding to a PDCP entity associated with the first radio bearer, a value of SN of a state variable belonging to the first state variable group of a PDCP entity associated with the second radio bearer is a truncated value of an SN part of a state variable corresponding to a PDCP entity associated with the first radio bearer.

In one embodiment, when a pdcp-SN-SizeDL of a PDCP entity associated with the second radio bearer is less than a pdcp-SN-SizeDL of a PDCP entity associated with the first radio bearer, a value of an HFN part of a state variable belonging to the first state variable group of a PDCP entity associated with the second radio bearer is equal to a value of an HFN part of a state variable corresponding to a PDCP entity associated with the first radio bearer, a value of SN of a state variable belonging to the first state variable group of a PDCP entity associated with the second radio bearer is a truncated value of an SN part of a state variable corresponding to a PDCP entity associated with the first radio bearer.

In one subembodiment of the above embodiment, a truncated length of the truncated value is equal to a difference of a pdcp-SN-SizeDL of a PDCP entity associated with the first radio bearer and a pdcp-SN-SizeDL of a PDCP entity associated with the second radio bearer.

In one subembodiment of the above embodiment, truncation of the truncated value is low truncation.

In one subembodiment of the above embodiment, truncation of the truncated value is high truncation.

In one embodiment, when a pdcp-SN-SizeDL of a PDCP entity associated with the second radio bearer is greater than a pdcp-SN-SizeDL of a PDCP entity associated with the first radio bearer, a value of an HFN part of a state variable belonging to the first state variable group of a PDCP entity associated with the second radio bearer is equal to a value of an HFN part of a state variable corresponding to a PDCP entity associated with the first radio bearer, a value of SN of a state variable belonging to the first state variable group of a PDCP entity associated with the second radio bearer is obtained by zero padding an SN part of a state variable corresponding to a PDCP entity associated with the first radio bearer.

In one subembodiment of the above embodiment, a zero-padding length obtained by zero padding the SN part is equal to a different of a pdcp-SN-SizeDL of a PDCP entity associated with the second radio bearer and a pdcp-SN-SizeDL of a PDCP entity associated with the first radio bearer.

In one subembodiment of the above embodiment, the zero padding obtained by zero padding the SN part is low truncation.

In one subembodiment of the above embodiment, the zero padding obtained by zero padding the SN part is high truncation.

In one embodiment, the first report is a PDCP status report, the first node U01 generates the first report according to a PDCP entity associated with the first radio bearer, and the first node U01 transmits the first report through a radio bearer whose bearer type is unicast bearer in the first radio bearer and the second radio bearer.

In one embodiment, the first report is a PDCP status report, and the first node U01 generates the first report according to a state variable of a PDCP entity associated with the first radio bearer.

In one embodiment, the first report is a PDCP status report, and the first node U01 generates the first report according to a COUNT of a PDCP entity associated with the first radio bearer.

In one embodiment, the first report is a PDCP status report, and the first node U01 generates the first report according to an RX_NEXT and an RX_DELIV of a PDCP entity associated with the first radio bearer.

In one embodiment, a serving cell of the first node U01 indicates that the first radio bearer is associated with the second radio bearer.

In one embodiment, a serving cell of the first node U01 indicates that the first report is generated according to a PDCP entity associated with the first radio bearer.

In one embodiment, a serving cell of the first node U01 indicates an identity of a radio bearer used for generating the first report, and the identity of the radio bearer is an identity of the first radio bearer.

In one embodiment, a serving cell of the first node U01 indicates a drb-Identity of a radio bearer used for generating the first report, and the drb-Identity is an identity of the first radio bearer.

In one embodiment, a serving cell of the first node U01 indicates an mrb-Identity of a radio bearer used for generating the first report, and the mrb-Identity is an identity of the first radio bearer.

In one embodiment, a serving cell of the first node U01 indicates an sc-mrb-Identity of a radio bearer used for generating the first report, and the sc-mrb-Identity is an identity of the first radio bearer.

In one embodiment, a serving cell of the first node U01 indicates an scmrb-Identity of a radio bearer used for generating the first report, and the scmrb-Identity is an identity of the first radio bearer.

In one embodiment, a PDCP associated with the second radio bearer assumes that a generation of the first report is based on the first radio bearer.

In one embodiment, when the first radio bearer is a unicast bearer, the first report is transmitted as a PDCP status report of the first radio bearer.

In one embodiment, when the second radio bearer is a unicast bearer, the first report is transmitted as a PDCP status report of the second radio bearer.

In one embodiment, when the first radio bearer is a unicast bearer, a PDCP entity of the first radio bearer generates the first report and transmits the generated first report.

In one embodiment, when the first radio bearer is a unicast bearer and the first condition is satisfied, a PDCP entity of the first radio bearer generates the first report and transmits the generated first report.

In one embodiment, when the first radio bearer is a unicast bearer, a PDCP entity of the second radio bearer generates the first report and transmits the generated first report based on a PDCP entity of the first radio bearer.

In one embodiment, when the first radio bearer is a unicast bearer and the first condition is satisfied, a PDCP entity of the second radio bearer generates the first report and transmits the generated first report based on a PDCP entity of the first radio bearer.

### Embodiment 5B

Embodiment 5B is based on Embodiment 5A, targeted scenarios include: a servicing cell of the first node U01 decides to switch a radio bearer of the first service from a unicast bearer to a non-unicast bearer. For steps required but not illustrated in detail in Embodiment 5B, refer to Embodiment 5A, and for drawing, refer to FIG. 5A. In particular, in Embodiment 5A, step S5103 is unnecessary; and the second node transmits a first service through a second radio bearer in step S5206.

In one embodiment, the first radio bearer is a unicast bearer.

In one embodiment, the first radio bearer is a DRB.

In one embodiment, the second signaling is transmitted in a unicast way.

In one embodiment, the second signaling is transmitted through a downlink DCCH channel.

In one embodiment, the second signaling is an RRC signaling.

In one embodiment, the second signaling is a MAC CE.

In one embodiment, the second signaling is an RRCReconfiguration message.

In one embodiment, the second signaling is an RRCConnectionReconfiguration message.

In one embodiment, the second signaling is an SIB.

In one embodiment, the second signaling indicates that a transmission of the first service is modified from the first radio bearer to the second radio bearer.

In one embodiment, the second signaling is transmitted in a unicast way, and the second signaling carries control information related to multicast service.

In one embodiment, the second signaling is transmitted in a unicast way, and the second signaling carries SIB related to multicast service.

In one embodiment, the second signaling is transmitted in a unicast way, and the second signaling carries SC-MTCH configuration related to multicast service.

In one embodiment, the second signaling is transmitted in a unicast way, and the second signaling carries a configuration of QoS flow related to the first service.

In one embodiment, the second signaling indicates releasing the first radio bearer.

In one embodiment, the second signaling indicates suspending the first radio bearer.

In one embodiment, the second signaling indicates a QoS flow of the first service is not mapped onto the first radio bearer.

In one embodiment, the first signaling indicates that a transmission of the first service is modified from the first radio bearer to the second radio bearer, then steps S5202 and S5102 are unnecessary.

In one embodiment, the second radio bearer is a non-unicast bearer.

In one embodiment, the second radio bearer is a broadcast bearer.

In one embodiment, the second radio bearer is a groupcast bearer.

In one embodiment, the second radio bearer is an MRB bearer.

In one embodiment, the second radio bearer is an SC-MRB bearer.

In one embodiment, the phrase that the second signaling indicates that a transmission of the first service is modified from the first radio bearer to the second radio bearer includes the following meaning: the second signaling indicates that a transmission of the first service is modified from the first radio bearer to the second radio bearer.

In one embodiment, the phrase that the second signaling indicates that a transmission of the first service is modified from the first radio bearer to the second radio bearer includes the following meaning: the second signaling indicates that the first service starts being transmitted on the second radio bearer.

In one embodiment, the phrase that the second signaling indicates that a transmission of the first service is modified from the first radio bearer to the second radio bearer includes the following meaning: a configuration of the first service is comprised in an SIB related to multicast, and is comprised in a control channel related to multicast service.

In one embodiment, the phrase that the second signaling indicates that a transmission of the first service is modified from the first radio bearer to the second radio bearer includes the following meaning: a configuration of the first service is comprised in an SIB related to multicast, and is comprised in transmission channel scheduling information related to multicast service.

In one embodiment, the first signaling is a higher layer signaling transmitted on a control channel related to multicast service.

In one embodiment, the first signaling is an RRC signaling transmitted through broadcast way.

In one embodiment, the first signaling is an RRC signaling transmitted through unicast way.

In one embodiment, the first signaling is an RRCReconfiguration message.

In one embodiment, the first signaling is an RRCConnectionReconfiguration message.

In one embodiment, the first signaling comprises an RRC signaling transmitted on an MCCH channel.

In one embodiment, the first signaling comprises an RRC signaling transmitted on an SC-MCCH channel.

In one embodiment, the first signaling comprises an SIB.

In one embodiment, the first signaling comprises an SIB related to multicast service.

In one embodiment, the first signaling comprises sc-mtch-SchedulingInfo.

In one embodiment, the first report comprises a PDCP Status Report.

In one embodiment, the first report comprises a PDCP status report, and the first report is generated by a PDCP entity associated with the first radio bearer of the first node U01.

In one embodiment, the first report comprises a PDCP status report, and the first report is transmitted by the first radio bearer.

In one embodiment, when the first report is transmitted, the first radio bearer is suspended.

In one embodiment, when the first report is transmitted, the first radio bearer is released.

In one embodiment, when the first report is transmitted, the first radio bearer is reserved.

In one embodiment, the first report is an RRC signaling.

In one embodiment, the first report is a control plane message.

In one embodiment, the first report comprises an MBMSInterestIndication.

In one embodiment, the first report comprises ueAssistanceInformation.

In one embodiment, the first report comprises a dedicatedSIBRequest-r16.

In one embodiment, the first report comprises a ueInformationResponse-r16.

In one embodiment, the first report comprises a ueAssistanceInformationEUTRA-r16.

In one embodiment, the first report comprises an MBMSInterestIndication-r17.

In one embodiment, the first report comprises a ueAssistanceInformation-r17.

In one embodiment, the first report comprises a ueAssistanceInformation-r17.

In one embodiment, the first report comprises an MBMSInterestIndication1.

In one embodiment, the first report comprises an MBMSInterestIndication2.

In one embodiment, a logical channel occupied by the first report comprises a DCCH.

In one embodiment, a physical channel occupied by the first report comprises a PUSCH.

In one embodiment, the second node N02 transmits the first service through the second radio bearer.

### Embodiment 5C

Embodiment 5C is based on Embodiment 5A, and targeted scenarios include: a servicing cell of the first node U01 decides to switch a radio bearer of the first service from a non-unicast bearer to a unicast bearer. For steps required but not illustrated in detail in Embodiment 5C, refer to Embodiment 5A, and for drawing, refer to FIG. 5A.

In one embodiment, the first radio bearer is a non-unicast bearer.

In one embodiment, the first radio bearer is a broadcast bearer.

In one embodiment, the first radio bearer is a groupcast bearer.

In one embodiment, the first radio bearer is an MRB bearer.

In one embodiment, the first radio bearer is an SC-MRB bearer.

In one embodiment, the second signaling is a higher layer signaling transmitted on a control channel related to multicast service.

In one embodiment, the second signaling is an RRC signaling transmitted through broadcast way.

In one embodiment, the second signaling is an RRC signaling transmitted through unicast way.

In one embodiment, the second signaling is an RRCReconfiguration message.

In one embodiment, the second signaling is an RRCConnectionReconfiguration message.

In one embodiment, the second signaling comprises an RRC signaling transmitted on an MCCH channel.

In one embodiment, the second signaling comprises an RRC signaling transmitted on an SC-MCCH channel.

In one embodiment, the second signaling comprises an SIB.

In one embodiment, the second signaling comprises an SIB related to multicast service.

In one embodiment, the second signaling comprises sc-mtch-SchedulingInfo.

In one embodiment, the second signaling indicates that a transmission of the first service is modified from the first radio bearer to the second radio bearer.

In one embodiment, the phrase that the second signaling indicates that a transmission of the first service is modified from the first radio bearer to the second radio bearer includes the following meaning: the second signaling indicates that a transmission of the first service is modified from the first radio bearer to the second radio bearer.

In one embodiment, the phrase that the second signaling indicates that a transmission of the first service is modified s from the first radio bearer to the second radio bearer includes the following meaning: the second signaling indicates that the first service starts being transmitted on the second radio bearer.

In one embodiment, the phrase that the second signaling indicates that a transmission of the first service is modified from the first radio bearer to the second radio bearer includes the following meaning: the second signaling indicates releasing the first radio bearer.

In one embodiment, the phrase that the second signaling indicates that a transmission of the first service is modified from the first radio bearer to the second radio bearer includes the following meaning: the second signaling indicates suspending the first radio bearer.

In one embodiment, the phrase that the second signaling indicates that a transmission of the first service is modified from the first radio bearer to the second radio bearer includes the following meaning: the second signaling indicates a QoS flow of the first service is not mapped onto the first radio bearer.

In one embodiment, the phrase that the second signaling indicates that a transmission of the first service is modified from the first radio bearer to the second radio bearer includes the following meaning: the second signaling indicates that a bearing type of the first service changes.

In one embodiment, the phrase that the second signaling indicates that a transmission of the first service is modified from the first radio bearer to the second radio bearer includes the following meaning: the second signaling indicates that a bearing type of the first service changes from a non-multicast bearer to a unicast bearer.

In one embodiment, the phrase that the second signaling indicates that a transmission of the first service is modified from the first radio bearer to the second radio bearer includes the following meaning: a configuration of the first service is only comprised in an SIB instead of in a control channel related to multicast service.

In one embodiment, the phrase that the second signaling indicates that a transmission of the first service is modified from the first radio bearer to the second radio bearer includes the following meaning: a configuration of the first service is only comprised in an SIB instead of in transmission channel scheduling information related to multicast service.

In one embodiment, the first information is used for triggering the first signaling.

In one embodiment, the first information comprises an RRC signaling.

In one embodiment, the first information comprises a MAC CE.

In one embodiment, a physical channel occupied by the first information comprises a PUSCH.

In one embodiment, the first information indicates requesting a reception of the first service.

In one embodiment, the first information indicates requesting a reception of the first service through a unicast bearer.

In one embodiment, the first information indicates establishing a unicast bearer to receive the first service.

In one embodiment, the first information comprises an RRCSetupRequest message.

In one embodiment, the first information comprises an RRCResumeRequest message.

In one embodiment, the first information comprises an RRCResumeRequest1 message.

In one embodiment, the first node U01 is in an RRC connection mode to receive the second radio bearer.

In one embodiment, the first signaling is transmitted in a unicast way.

In one embodiment, the first signaling is transmitted through a downlink DCCH channel.

In one embodiment, the first signaling is an RRC signaling.

In one embodiment, the first signaling is a MAC CE.

In one embodiment, the first signaling is an RRCReconfiguration message.

In one embodiment, the first signaling is an RRCConnectionReconfiguration message.

In one embodiment, the first signaling indicates establishing the second radio bearer.

In one embodiment, the first signaling indicates that a QoS flow of the first service is mapped onto the second radio bearer.

In one embodiment, the first report comprises a PDCP Status Report.

In one embodiment, the first report is generated according to a PDCP entity associated with the first radio bearer.

In one embodiment, the first report is transmitted through the second radio bearer.

In one embodiment, the first report comprises an RRC signaling.

In one embodiment, the first report and the first information are multiplexed in a same PDU.

In one embodiment, the first information carries the first report.

In one embodiment, the second radio bearer is a unicast bearer.

In one embodiment, the second radio bearer is a DRB.

In one embodiment, the second node N02 transmits the first service through the second radio bearer in step S5206.

In one embodiment, the first node U01 receives the first service through the second radio bearer in step S5106.

### Embodiment 5D

Embodiment 5D is based on Embodiment 5A, and targeted scenarios include: the first node U01 switches from one cell transmitting the first service through a unicast bearer to another cell transmitting the first service through a non-unicast bearer. For steps required but not illustrated in detail in Embodiment 5D, refer to Embodiment 5A, and for drawing, refer to FIG. 5A. In particular, in Embodiment 5D, step S5206 is unnecessary.

In one embodiment, the first radio bearer is a unicast bearer.

In one embodiment, the first radio bearer is a DRB.

In one embodiment, the second signaling comprises a higher-layer signaling.

In one embodiment, the second signaling comprises an RRC signaling.

In one embodiment, the second signaling comprises an RRCReconfiguration.

In one embodiment, the second signaling comprises an RRCConnectionReconfiguration.

In one embodiment, the second signaling comprises an MBMSCountingRequest.

In one embodiment, the second signaling comprises an MBSCountingRequest.

In one embodiment, the second signaling comprises an SC-PTMCountingRequest.

In one embodiment, the second signaling comprises a ueInformationRequest-r9.

In one embodiment, the second signaling comprises a ueInformationRequest.

In one embodiment, the second signaling comprises a ueInformationRequest-r17.

In one embodiment, the first information comprises an RRC signaling.

In one embodiment, the first information comprises a MAC CE.

In one embodiment, a physical channel occupied by the first information comprises a PUSCH.

In one embodiment, the first information indicates that the first service is being received.

In one embodiment, the first information comprises an MBMSCountingResponse.

In one embodiment, the first information comprises an MBSCountingResponse.

In one embodiment, the first information comprises an SC-PTMCountingResponse.

In one embodiment, the first signaling indicates that a transmission of the first service is modified from the first radio bearer to the second radio bearer, then the step S5202 and the step S5102 are unnecessary.

In one embodiment, the second node N02 owns information that the first node U01 is receiving the first service, then steps S5203 and S5103 are unnecessary.

In one embodiment, context of the first node U01 owned by the second node N02 includes that the first node U01 is receiving information of the first service, and steps S5203 and S5103 are unnecessary.

In one embodiment, the first signaling comprises an RRCReconfiguration.

In one embodiment, the first signaling comprises an RRCConnectionReconfiguration.

In one embodiment, the first signaling comprises an ReconfigurationWithSync.

In one embodiment, the first signaling comprises an SIB of a target cell of the first node U01.

In one embodiment, the first signaling comprises an SIB related to multicast service of a target cell of the first node U01.

In one embodiment, the first signaling comprises an SIB related to the first service of a target cell of the first node U01.

In one embodiment, the first signaling comprises control information related to multicast service of a target cell of the first node U01.

In one embodiment, the first signaling comprises a control signaling transmitted on an MCCH of a target cell of the first node U01.

In one embodiment, the first signaling comprises an RRC message transmitted on an MCCH of a target cell of the first node U01.

In one embodiment, the first signaling comprises a control signaling transmitted on an SC-MCCH of a target cell of the first node U01.

In one embodiment, the first signaling comprises an RRC message transmitted on an SC-MCCH of a target cell of the first node U01.

In one embodiment, the first signaling comprises configuration information related to the second radio bearer of a target cell of the first node U01.

In one embodiment, the first signaling comprises configuration information of the second radio bearer used for establishing the first service of a target cell of the first node U01.

In one embodiment, the first node U01 establishes the second radio bearer related to the first service according to an indication of the first signaling.

In one embodiment, the first node U01 transmits the first report before receiving the first signaling.

In one embodiment, the first node U01 transmits the first report after receiving the first signaling.

In one embodiment, the first signaling triggers the first report.

In one embodiment, the first report triggers the first signaling.

In one embodiment, the first node U01 receives the first service through the second radio bearer in a target cell.

In one embodiment, a target cell of the first node U01 transmits the first service through the second radio bearer.

In one embodiment, the second radio bearer is a non-unicast bearer.

In one embodiment, advantages of the above method include that when the first node U01 carries out cell handover, carrying multicast service configuration information of a neighbor cell can help the first node U01 to quickly establish a bearer to reduce possibility of time delay and data interruption.

In one embodiment, advantages of the above method include that when the first node U01 carries out cell handover, by transmitting the first report related to reception condition, a base station of the first node can control transmission of the first service in the cell better and the second radio bearer can also be configured better.

### Embodiment 5F

Embodiment 5F illustrates a flowchart of radio signal transmission according to one embodiment in the present disclosure, as shown in FIG. 5B. In FIG. 5B, U01d corresponds to a first node in the present disclosure, N02d corresponds to a second node in the present disclosure. It is particularly underlined that the order illustrated in the embodiment does not put constraints over sequences of signal transmissions and implementations and the step in F51d is optional.

The second node N02d transmits a first measurement configuration group and a first report configuration group in step S5201d;

The first node U01d receives a first measurement configuration group and a first report configuration group in step S510d, and performs a first channel measurement on a first reference signal set in step S5102;

in Embodiment 5F, the first measurement configuration group comprises a first measurement configuration sub-group; the first measurement configuration sub-group indicates the first reference signal set; the first measurement configuration sub-group is a non-unicast upper layer signaling, and the first report configuration group is a unicast upper layer signaling.

In one embodiment, the node N02d transmits the first measurement configuration sub-group through a broadcast way.

In one embodiment, the node N02d transmits the first measurement configuration sub-group through a groupcast way.

In one embodiment, the node N02d is a serving cell of the node U01d.

In one embodiment, the node N02d is a primary serving cell of the node U01d.

In one embodiment, the node N02d is a secondary serving cell of the node U01d.

In one embodiment, when the node U01d receives the first measurement configuration sub-group, there is no signaling bearer other than SRBO in the node U01d and the node N02d.

In one embodiment, when the node U01d receives the first measurement configuration sub-group, there is a signaling bearer other than SRBO in the node U01d and the node N02d.

In one embodiment, the node N02d indicates that there exists the first measurement configuration sub-group via a broadcast signaling.

In one embodiment, the node U01d reports to the node N02d that the node U01d has a capability of receiving the first measurement configuration sub-group.

In one embodiment, the first reference signal set comprises a synchronization signal transmitted by the node N02d.

In one embodiment, the first reference signal set comprises a reference signal transmitted by the node N02d.

In one embodiment, the first reference signal set comprises a CSI-RS signal transmitted by the node N02d.

In one embodiment, the first reference signal set comprises a synchronization signal transmitted by a node other than the node N02d.

In one embodiment, the first reference signal set comprises a reference signal transmitted by a node other than the node N02d.

In one embodiment, the first reference signal set comprises a CSI-RS signal transmitted by a node other than the node N02d.

In one embodiment, the first measurement configuration sub-group comprises a time parameter D1, and the D1 is used for controlling the first channel measurement.

In one embodiment, the first channel measurement lasts at least D1 time.

In one embodiment, a result of the first channel measurement is an average value of measurement values in D1 time.

In one embodiment, the first measurement configuration sub-group comprises a first parameter, and the first parameter is used for controlling the first channel measurement.

In one embodiment, the first parameter number of reference signal(s) in the first reference signal set is(are) used together for generating a measurement result.

In one embodiment, an average value of measurement(s) of the first parameter number of reference signal(s) in the first reference signal set is used for generating a measurement result.

In one embodiment, a maximum value of measurement(s) of the first parameter number of reference signal(s) in the first reference signal set is used for generating a measurement result.

In one embodiment, the node U01d performs a second channel measurement on a second reference signal set in step S5102d;

herein, the first measurement configuration group comprises a second measurement configuration sub-group; the second measurement configuration sub-group indicates the second reference signal set; the second measurement configuration sub-group is a unicast upper layer signaling.

In one embodiment, the first measurement configuration sub-group is orthogonal to the second measurement configuration sub-group.

In one embodiment, the second measurement configuration sub-group comprises a MeasIdToAddMod.

In one embodiment, the identity of the second measurement configuration sub-group is a measId.

In one embodiment, the second measurement configuration sub-group is saved by the node U01d in VarMeasConfig.

In one embodiment, the second measurement configuration sub-group is transmitted through a channel other than a BCH.

In one embodiment, the second measurement configuration sub-group is transmitted through a PDSCH channel.

In one embodiment, the second measurement configuration sub-group is transmitted through a PDCCH channel.

In one embodiment, the second measurement configuration sub-group is transmitted via an RRCRelease message.

In one embodiment, the second measurement configuration sub-group is transmitted via an RRCReconfiguration message.

In one embodiment, the second measurement configuration sub-group is transmitted via an RRCSetup message.

In one embodiment, the second measurement configuration sub-group is transmitted via an RRCResume message.

In one embodiment, the second measurement configuration sub-group is transmitted via an RRCConnectionRelease message.

In one embodiment, the second measurement configuration sub-group is transmitted via an RRCConnectionReconfiguration message.

In one embodiment, the second measurement configuration sub-group is transmitted via an RRCConnectionSetup message.

In one embodiment, the second measurement configuration sub-group is transmitted via an RRCConnectionResume message.

In one embodiment, the node U01d is in a same RRC mode when receiving the second measurement configuration sub-group and performing a second channel measurement on a first reference signal set.

In one embodiment, the node U01d is in different RRC modes when receiving the second measurement configuration sub-group and performing a second channel measurement on a first reference signal set.

In one embodiment, each the measurement item comprised in the second measurement configuration sub-group corresponds to an item in comprised measIdToAddModList.

In one embodiment, the second reference signal set comprises a synchronization signal.

In one embodiment, a channel occupied by the second reference signal set comprises a PBCH.

In one embodiment, the synchronization signal comprises a PSS and an SSS.

In one embodiment, the second reference signal set comprises an RS.

In one embodiment, the second reference signal set comprises a CRS.

In one embodiment, the second reference signal set comprises a CSI-RS.

In one embodiment, the second reference signal set comprises a PT-RS.

In one embodiment, the second reference signal set comprises a DMRS.

In one embodiment, the second channel measurement comprises an RSRP measurement performed on the second reference signal set.

In one embodiment, the second channel measurement comprises an RSRQ measurement performed on the second reference signal set.

In one embodiment, the second channel measurement comprises an RSSI measurement performed on the second reference signal set.

In one embodiment, the second channel measurement comprises an SNR measurement performed on the second reference signal set.

In one embodiment, the second channel measurement comprises a hypothetical measurement performed on the second reference signal set.

In one embodiment, the hypothetical measurement comprises inferring a BLER of a first channel based on a measurement performed on the second reference signal set.

In one embodiment, the hypothetical measurement comprises inferring a BLER of a first bearer based on a measurement performed on the second reference signal set.

In one embodiment, the first channel comprises a physical layer channel.

In one embodiment, the first channel comprises a transport layer channel.

In one embodiment, the first channel comprises a logical channel.

In one embodiment, the first bearer comprises a radio bearer.

In one embodiment, the first bearer comprises a radio access bearer.

In one embodiment, the first bearer comprises a cable bearer.

In one embodiment, the first bearer comprises an IP bearer.

In one embodiment, the first bearer comprises a unicast bearer.

In one embodiment, the first bearer comprises a groupcast bearer.

In one embodiment, the first bearer comprises a broadcast bearer.

In one embodiment, the first channel comprises a PDCCH.

In one embodiment, the first channel comprises a PDSCH.

In one embodiment, the first channel comprises a PBCH.

In one embodiment, the according to a measurement performed on the second reference signal set comprises a measurement performed on an RSRP.

In one embodiment, the according to a measurement performed on the second reference signal set comprises a measurement performed on an RSRQ.

In one embodiment, the according to a measurement performed on the second reference signal set comprises a measurement performed on an RSSI.

In one embodiment, the according to a measurement performed on the second reference signal set comprises a measurement performed on an SNR.

In one embodiment, the node U01d determines that the first condition is satisfied in step S5104d.

In one embodiment, the node U01d transmits the first report information group in step S5105d.

In one embodiment, the node N02d receives the first report information group in step S5202d.

In one embodiment, the first report information group comprises a result of the first channel measurement.

In one embodiment, the first report information group comprises a result of the second channel measurement.

In one embodiment, the first report information group comprises a first report information sub-group and a second report information sub-group, the first report information sub-group comprises the result of the first channel measurement, and the second report information sub-group comprises the result of the second channel measurement.

In one embodiment, the first report information sub-group comprises an identity of the first measurement configuration sub-group, and the second report information sub-group comprises an identity of the second measurement configuration sub-group.

### Embodiment 6A

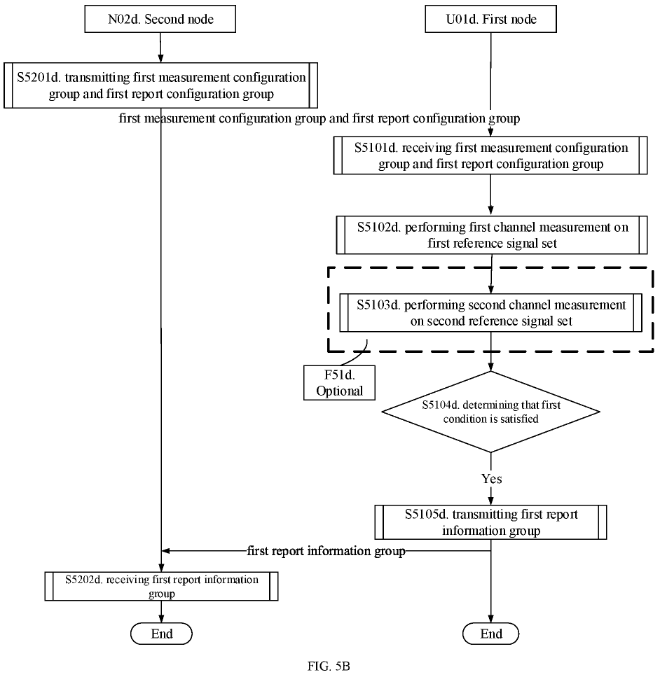

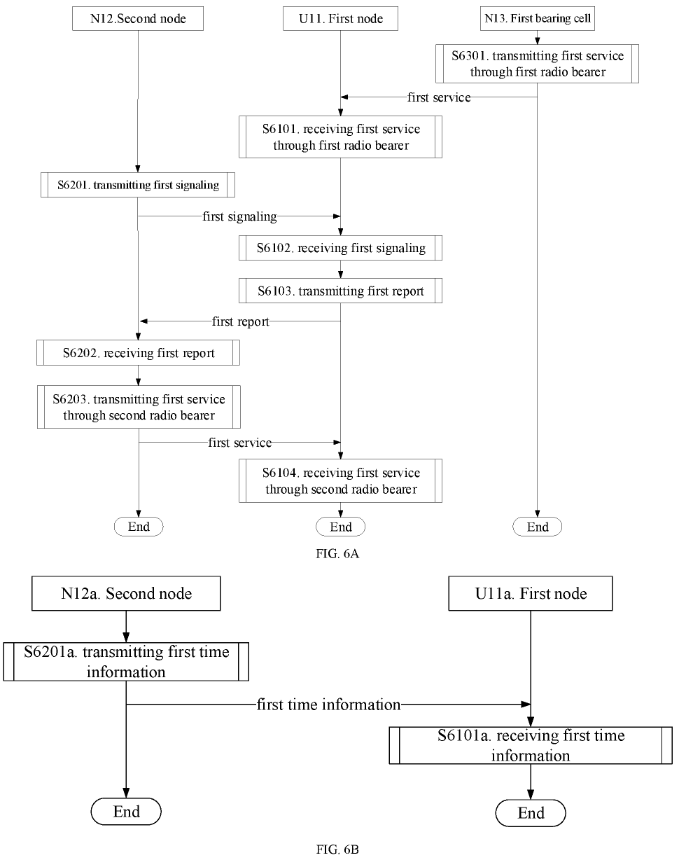

Embodiment 6 illustrates a flowchart of radio signal transmission according to one embodiment of the present disclosure, as shown in FIG. 6. In FIG. 6, U11 corresponds to a first node in the present disclosure, N12 corresponds to a second node in the present disclosure, N13 is a first bearing cell. It is particularly underlined that the order illustrated in the embodiment does not put constraints over sequences of signal transmissions and implementations.

The first node U11 receives a first service through a first radio bearer in step S6101; receives a first signaling in step S6102; transmits a first report in step S6103; and receives the first service through a second radio bearer in step S6104.

The second node N12 transmits the first signaling in step S6201; receives the first report in step S6202; and transmits the first service through the second radio bearer in step S6203.

The first bearing cell N13 transmits the first service through the first radio bearer in step S6301.

In Embodiment 6, the first node U11 receives the first service through at least a latter of the first radio bearer and the second radio bearer; when a first condition is satisfied, the first node U11 transmits the first report; the first condition comprises that a reception of the first service is modified from the first radio bearer to the second radio bearer; a bearer type of the first radio bearer is different from a bearer type of the second radio bearer, and the bearer type comprises a non-unicast bearer and a unicast bearer; the first report is used for indicating an SDU related to the first service and received through the first radio bearer, and the first report is upper layer control information.

In one embodiment, the first bearing cell N13 is a source cell of the first node U11, and the second node N12 is a target cell of the first node U11.

In one embodiment, the first node U11 is modified to the second node N12 from the first bearer cell N13.

In one embodiment, the first bearing cell N13 transmits the first service through the first radio bearer.

In one embodiment, the second node N12 transmits the first service through the second radio bearer.

In one embodiment, the first bearing cell N13 only transmits the first service to the first node U11 through the first radio bearer.

In one embodiment, the second node N12 only transmits the first service through the second radio bearer.

In one embodiment, the first radio bearer is unicast bearer, and the second radio bearer is a non-unicast bearer.

In one embodiment, the second radio bearer is a broadcast bearer.

In one embodiment, the second radio bearer is a groupcast bearer.

In one embodiment, the second radio bearer is an MRB bearer.

In one embodiment, the second radio bearer is an SC-MRB bearer.

In one embodiment, the second radio bearer is a DRB bearer identified as a groupcast bearer.

In one embodiment, the first radio bearer is a DRB bearer.

In one embodiment, the first radio bearer is a DRB bearer not identified as a groupcast bearer.

In one embodiment, the first node U11 is modified to the second node N12 by the first bearing cell N13.

In one embodiment, the first signaling is a higher layer signaling transmitted on a control channel related to multicast service.

In one embodiment, the first signaling is an RRC signaling transmitted through a broadcast way.

In one embodiment, the first signaling is an RRC signaling transmitted through a unicast way.

In one embodiment, the first signaling comprises an RRCReconfiguration message.

In one embodiment, the first signaling comprises an RRCConnectionReconfiguration message.

In one embodiment, the first signaling comprises RadioBearerConfig.

In one embodiment, the first signaling comprises RadioBearerConfig1.

In one embodiment, the first signaling comprises RadioBearerConfig2.

In one embodiment, the first signaling comprises RadioBearerConfig3.

In one embodiment, the first signaling comprises an RRC signaling transmitted on an MCCH channel.

In one embodiment, the first signaling comprises an RRC signaling transmitted on an SC-MCCH channel.

In one embodiment, the first signaling comprises an SIB.

In one embodiment, the first signaling comprises an SIB related to multicast service.

In one embodiment, the first signaling comprises sc-mtch-SchedulingInfo.

In one embodiment, the first signaling indicates that a transmission of the first service is modified from the first radio bearer to the second radio bearer.

In one embodiment, the first radio bearer is released during handover process, and the first report is an RRC signaling.

In one embodiment, the first radio bearer is released during handover process, the first report is a PDCP status report, and the first report is transmitted through a bearer other than the first radio bearer and the second radio bearer.

In one embodiment, the first radio bearer is not released during handover process, the first report is a PDCP status report, and the first report is transmitted through the first radio bearer.

In one embodiment, the first radio bearer is not released during handover process, the first report is an RRC signaling, and the first report is transmitted through a radio bearer other than the first radio bearer and the second radio bearer.

In one embodiment, the first signaling indicates establishing a second radio bearer for the first service.

In one embodiment, the first report comprises a PDCP Status Report.

In one embodiment, the first report comprises a PDCP status report, and the first report is generated by a PDCP entity associated with the first radio bearer of the first node U11.

In one embodiment, the first radio bearer is reserved after being modified.

In one embodiment, the first report is an RRC signaling.

In one embodiment, the first report is a control-plane message.

In one embodiment, the first report comprises an MBMSInterestIndication.

In one embodiment, the first report comprises ueAssistanceInformation.

In one embodiment, the first report comprises a dedicatedSIBRequest-r16.

In one embodiment, the first report comprises a ueInformationResponse-r16.

In one embodiment, the first report comprises a ueAssistanceInformationEUTRA-r16.

In one embodiment, the first report comprises an MBMSInterestIndication-r17.

In one embodiment, the first report comprises a ueAssistanceInformation-r17.

In one embodiment, the first report comprises a ueAssistanceInformarion-r17.

In one embodiment, the first report comprises an MBMSInterestIndication1.

In one embodiment, the first report comprises an MBMSInterestIndication2.

In one embodiment, a logical channel occupied by the first report comprises a DCCH.

In one embodiment, a physical channel occupied by the first report comprises a PUSCH.

In one embodiment, the second node transmits the first service through the first radio bearer and the second radio bearer at the same time.

In one embodiment, the second node transmits different packages of the first service through the first radio bearer and the second radio bearer.

In one embodiment, the second node transmits data of the first service not received by the first node U11 through the second radio bearer through the first radio bearer.

In one embodiment, the second node transmits the first service through the first radio bearer and the second radio bearer at the same time, and a state variable of a PDCP entity of the first radio bearer is synchronized with a state variable of the second radio bearer.

### Embodiment 6B

Embodiment 6B illustrates a flowchart of radio signal transmission according to one embodiment of the present disclosure, as shown in FIG. 6B. In FIG. 6B, U11a corresponds to a first node in the present disclosure, N12a corresponds to a second node in the present disclosure. It is particularly underlined that the order illustrated in the embodiment does not put constraints over sequences of signal transmissions and implementations.

The second node N12a transmits first time information in step S6201a;

The first node U11a receives the first time information in step S6101a;

In Embodiment 6a, the first time information is used for determining the first report information group.

In one embodiment, the node N02 is a serving cell of the node U11a.

In one embodiment, the node N02 is a primary serving cell of the node U11a.

In one embodiment, the node N02 is a secondary serving cell of the first node.

In one embodiment, the first time information indicates an item required to be comprised in the first report information group.

In one embodiment, the first time information indicates time limit of the first report information group.

In one embodiment, the node U11a reports the first report information group within time indicated by the first time information.

In one embodiment, a result of a measurement performed by the node U11a within a latest time indicated by the first time information is comprised in the first report information group.

In one embodiment, the measurement performed by the node U11a within a latest time indicated by the first time information comprises the first channel measurement.

In one embodiment, the measurement performed by the node U11a within a latest time indicated by the first time information comprises the second channel measurement.

In one embodiment, a result of a measurement obtained by the node U11a within a latest time indicated by the first time information is comprised in the first report information group.

In one embodiment, all measurement results comprised in the first report information group are obtained within a time indicated by the first time information.

In one embodiment, all measurement results comprised in the first report information group are generated within a time indicated by the first time information.

In one embodiment, the first time information is used for a filter applied to the first report information group.

In one embodiment, the first time information takes a system time as a reference.

In one embodiment, the first time information takes a transmission time of the first time information as a reference.

In one embodiment, the first time information takes a reception time of the first time information as a reference.

In one embodiment, the first time information is used for determining a time range of a measurement result comprised in the first report information group.

In one embodiment, the first report information group only comprises a measurement result in a time determined by the first time information.

In one embodiment, the first report information group only comprises a result of a measurement in a time determined by the first time information.

In one embodiment, the first report information group only comprises a latest measurement result in a time determined by the first time information.

In one embodiment, the first condition comprises the first time information.

### Embodiment 7A

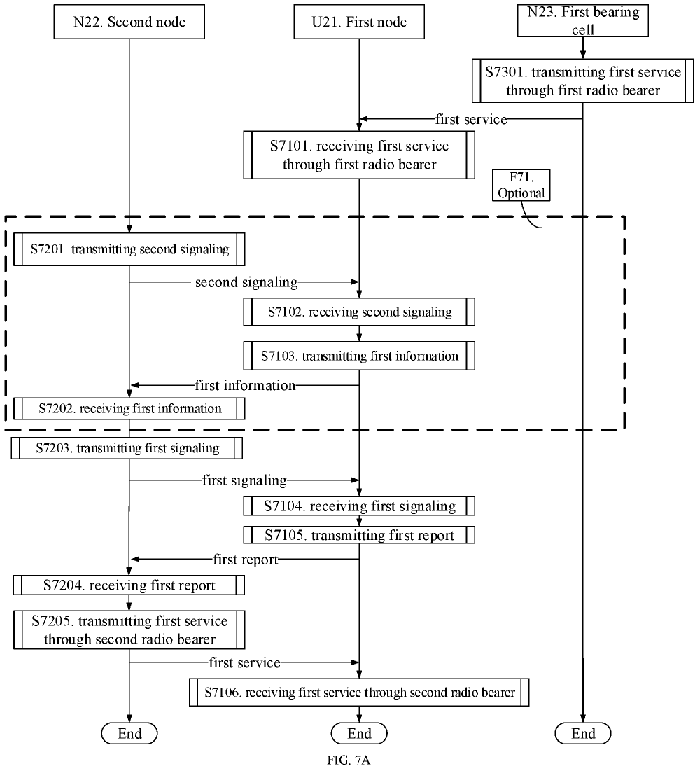

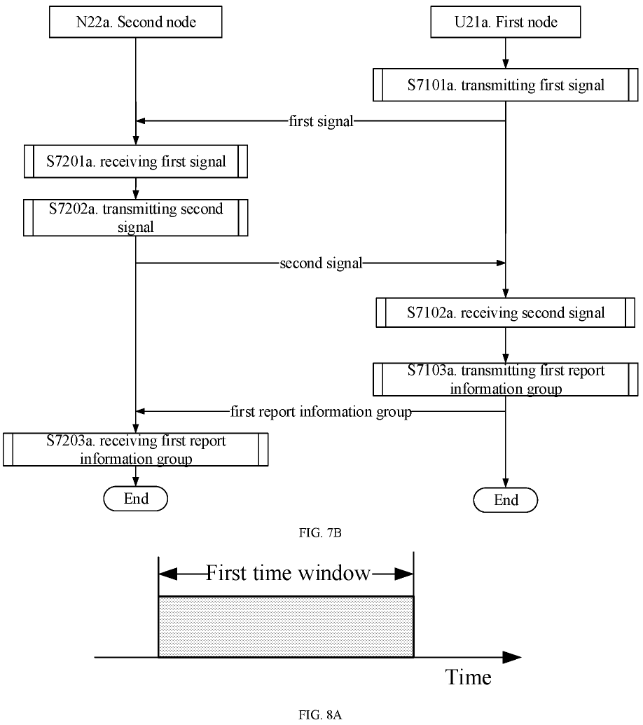

Embodiment 7 illustrates a flowchart of radio signal transmission according to one embodiment of the present disclosure, as shown in FIG. 7. In FIG. 7, U21 corresponds to a first node in the present disclosure, N22 corresponds to a second node in the present disclosure, N23 is a first bearing cell. It is particularly underlined that the order illustrated in the embodiment does not put constraints over sequences of signal transmissions and implementations, wherein steps in F71 are optional.

The first node U21 receives a first service through a first radio bearer in step S7101; receives a second signaling in step S7102; transmits first information in step S7103; receives a first signaling in step S7104; transmits a first report in step S7105; and receives the first service through a second radio bearer in step S7106.

The second node N22 transmits the second signaling in step S7201; receives the first information in step S7202; transmits the first signaling in step S7203; receives the first report in step S7204; and transmits the first service through the second radio bearer in step S7205.

The first bearing cell N23 transmits the first service through the first radio bearer in step S7301.

In Embodiment 7, the first node U21 receives the first service through at least a latter of the first radio bearer and the second radio bearer; when a first condition is satisfied, the first node U21 transmits the first report; the first condition comprises that a reception of the first service is modified from the first radio bearer to the second radio bearer; a bearer type of the first radio bearer is different from a bearer type of the second radio bearer, and the bearer type comprises a non-unicast bearer and a unicast bearer; the first report is used for indicating an SDU related to the first service and received through the first radio bearer, and the first report is upper layer control information.

In one embodiment, the first bearing cell N23 is a source cell of the first node U21, and the second node N22 is a target cell of the first node U21.

In one embodiment, the first node U21 is modified to the second node N22 from the first bearer cell N23.

In one embodiment, the first bearing cell N23 transmits the first service through the first radio bearer.

In one embodiment, the second node N22 transmits the first service through the second radio bearer.

In one embodiment, the first bearing cell N23 transmits the first service only through the first radio bearer.

In one embodiment, the second node N22 transmits the first service to the first node U21 only through the second radio bearer.

In one embodiment, the first radio bearer is non-unicast bearer, and the second radio bearer is a unicast bearer.

In one embodiment, the first radio bearer is a broadcast bearer.

In one embodiment, the first radio bearer is a groupcast bearer.

In one embodiment, the first radio bearer is an MRB bearer.

In one embodiment, the first radio bearer is an SC-MRB bearer.

In one embodiment, the first radio bearer is a DRB bearer identified as a group bearer.

In one embodiment, the second radio bearer is an DRB bearer.

In one embodiment, the second radio bearer is a DRB bearer not identified as a group bearer.

In one embodiment, the second signaling is a higher layer signaling transmitted on a control channel related to multicast service.

In one embodiment, the second signaling is an RRC signaling transmitted through a broadcast way.

In one embodiment, the second signaling comprises an RRC signaling transmitted on an MCCH channel.

In one embodiment, the second signaling comprises an RRC signaling transmitted on an SC-MCCH channel.

In one embodiment, the second signaling comprises an SIB.

In one embodiment, the second signaling comprises an SIB related to multicast service.

In one embodiment, the second signaling comprises sc-mtch-SchedulingInfo.

In one embodiment, the second signaling indicates that a transmission of the first service is modified from the first radio bearer to the second radio bearer.

In one embodiment, the phrase that the second signaling indicates that a transmission of the first service is modified from the first radio bearer to the second radio bearer includes the following meaning: the second signaling indicates that a receiver of the first service needs to establish a new radio bearer to receive the first service.

In one embodiment, the phrase that the second signaling indicates that a transmission of the first service is modified from the first radio bearer to the second radio bearer includes the following meaning: the second signaling indicates that a receiver of the first service needs to establish the second radio bearer to receive the first service.

In one embodiment, the phrase that the second signaling indicates that a transmission of the first service is modified from the first radio bearer to the second radio bearer includes the following meaning: the second signaling indicates a QoS flow of the first service is not mapped onto the first radio bearer.

In one embodiment, the phrase that the second signaling indicates that a transmission of the first service is modified from the first radio bearer to the second radio bearer includes the following meaning: the second signaling indicates that a bearing type of the first service changes.

In one embodiment, the phrase that the second signaling indicates that a transmission of the first service is modified from the first radio bearer to the second radio bearer includes the following meaning: the second signaling indicates that a bearing type of the first service changes from a non-multicast bearer to a unicast bearer.

In one embodiment, the phrase that the second signaling indicates that a transmission of the first service is modified from the first radio bearer to the second radio bearer includes the following meaning: the second signaling indicates that a bearing type of the first service is different from a type of the first radio bearer employed by the first node.

In one embodiment, the phrase that the second signaling indicates that a transmission of the first service is modified from the first radio bearer to the second radio bearer includes the following meaning: a configuration of the first service is only comprised in an SIB instead of in a control channel related to multicast service.

In one embodiment, the phrase that the second signaling indicates that a transmission of the first service is modified from the first radio bearer to the second radio bearer includes the following meaning: a configuration of the first service is only comprised in an SIB instead of in transmission channel scheduling information related to multicast service.

In one embodiment, the second signaling comprises a higher-layer signaling.

In one embodiment, the second signaling comprises an RRC signaling.

In one embodiment, the second signaling comprises an MBMSCountingRequest.

In one embodiment, the second signaling comprises an MBSCountingRequest.

In one embodiment, the second signaling comprises an SC-PTMCountingRequest.

In one embodiment, the second signaling comprises a ueInformationRequest-r9.

In one embodiment, the second signaling comprises a ueInformationRequest.

In one embodiment, the second signaling comprises a ueInformationRequest-r17.

In one embodiment, the first information indicates requesting a reception of the first service.

In one embodiment, the first information indicates requesting a reception of the first service through a unicast bearer.

In one embodiment, the first information indicates establishing a unicast bearer to receive the first service.

In one embodiment, the first information comprises an RRCSetupRequest message.

In one embodiment, the first information comprises an RRCResumeRequest message.

In one embodiment, the first information comprises an RRCResumeRequest1 message.

In one embodiment, the first information comprises an RRC signaling.

In one embodiment, the first information comprises a MAC CE.

In one embodiment, a physical channel occupied by the first information comprises a PUSCH.

In one embodiment, the first information indicates that the first service is being received.

In one embodiment, the first information comprises an MBMSCountingResponse.

In one embodiment, the first information comprises an MBSCountingResponse.

In one embodiment, the first information comprises an SC-PTMCountingResponse.

In one embodiment, the first information comprises an MBMSServiceRequest.

In one embodiment, the first information comprises an SC-PTMSServiceRequest.

In one embodiment, the first information comprises an MBMSInterestIndication.

In one embodiment, the first information comprises an MBMSInterestIndication1.

In one embodiment, the first information comprises an SC-PTMInterestIndication1.

In one embodiment, the first signaling comprises a higher-layer signaling.

In one embodiment, the first signaling comprises an RRC signaling.

In one embodiment, the first signaling comprises an RRCReconfiguration.

In one embodiment, the first signaling comprises an RRCConnectionReconfiguration.

In one embodiment, the first signaling indicates the second radio bearer establishing the first service.

In one embodiment, the first signaling indicates a configuration of the second radio bearer.

In one embodiment, the first report is an RRC signaling.

In one embodiment, the first report is a control plane message.

In one embodiment, the first report comprises an MBMSInterestIndication.

In one embodiment, the first report comprises ueAssistanceInformation.

In one embodiment, the first report comprises a dedicatedSIBRequest-r16.

In one embodiment, the first report comprises a ueInformationResponse-r16.

In one embodiment, the first report comprises a ueAssistanceInformationEUTRA-r16.

In one embodiment, the first report comprises an MBMSInterestIndication-r17.

In one embodiment, the first report comprises ueAssistanceInformarion-r17.

In one embodiment, the first report comprises ueAssistanceInformarion-r17.

In one embodiment, the first report comprises an MBMSInterestIndication1.

In one embodiment, the first report comprises an MBMSInterestIndication2.

In one embodiment, a logical channel occupied by the first report comprises a DCCH.

In one embodiment, a physical channel occupied by the first report comprises a PUSCH.

In one embodiment, the first report comprises a PDCP Status Report.

In one embodiment, the first report comprises a PDCP status report, and the first report is generated according to a PDCP entity associated with the first radio bearer of the first node U21.

In one embodiment, the first report comprises a PDCP status report, and the first report is transmitted by the second radio bearer.

In one embodiment, the first report is a PDCP status report, a first status variable group is a subset of a set consists of all status variables of a PDCP entity associated with the second radio bearer, and the first signaling indicates that a value of a status variable in the first status variable group is determined by a value of a status variable corresponding to a PDCP entity associated with the first radio bearer; the first node U21 generates the first report according to a PDCP entity associated with the second radio bearer, and the first node U21 transmits the first report through the second radio bearer.

### Embodiment 7B

Embodiment 7B illustrates a flowchart of radio signal transmission according to one embodiment of the present disclosure, as shown in FIG. 7B. In FIG. 7B, U21a corresponds to a first node in the present disclosure, N22a corresponds to a second node in the present disclosure. It is particularly underlined that the order illustrated in the embodiment does not put constraints over sequences of signal transmissions and implementations.

The first node U21a transmits a first signal in step S7101a;

the second node N22a receives the first signal in step S7201a;

in Embodiment 7B, the first signal is used for triggering the second signal, and the first condition includes that the second signal is received.

In one embodiment, the node N22a transmits the second signal in step S7202a.

In one embodiment, the node U21a receives the second signal in step S7102a.

In one embodiment, the node U21a transmits a first report information group in step S7103a.

In one embodiment, the node U22a receives the first report information in step S7203a.

In one embodiment, the node N22a is a serving cell of the node U21a.

In one embodiment, the node N22a is a primary serving cell of the node U21a.

In one embodiment, the node N22a is a secondary serving cell of the node U21a.

In one embodiment, the node U21a performs a first channel measurement on a first reference signal set.

In one embodiment, the node U21a performs a second channel measurement on a second reference signal set.

In one embodiment, the first reference signal set and the second reference signal are configured by the node N02.

In one embodiment, the first reference signal set and the second reference signal are configured by a first measurement configuration group transmitted by the node N02.

In one embodiment, the first signal is used for indicating that the node U21a obtains a result of a first channel measurement.

In one embodiment, the first signal is used for indicating that there exists a sub-item in a VarMeasReportList.

In one embodiment, the first signal is used for indicating that there exists a sub-item related to the first measurement configuration group in a VarMeasReportList.

In one embodiment, the first signal is used for indicating that there exists a measurement result obtained from a measurement performed on the first measurement configuration group in a VarMeasReportList.

In one embodiment, the first signal is used for indicating that there exists a measurement result obtained from a measurement performed on the first measurement configuration group in the node U21a.

In one embodiment, the first signal is used for indicating time information of a measurement result saved by the node U21a.

In one embodiment, the first signal is used for indicating time information of the first channel measurement saved by the node U21a.

In one embodiment, the first signal is used for indicating time information of the second channel measurement saved by the node U21a.

In one embodiment, a measurement result saved by the node U21a comprises a result of the first channel measurement.

In one embodiment, a measurement result saved by the node U21a comprises a result of the second channel measurement.

In one embodiment, the first signal is transmitted in a unicast way.

In one embodiment, the first signal comprises a MAC CE.

In one embodiment, the first signal comprises an RRC signaling.

In one embodiment, the first signal is transmitted through a PUSCH channel.

In one embodiment, the first signal is transmitted through a PUCCH channel.

In one embodiment, the first signal is transmitted through an RRCReconfigurationComplete message.

In one embodiment, the first signal is transmitted through an RRCSetupRequest message.

In one embodiment, the first signal is transmitted through an RRCResumeRequest message.

In one embodiment, the first signal is transmitted through an RRCResumeRequest1 message.

In one embodiment, the first signal is transmitted through an RRCConnectionReconfigurationComplete message.

In one embodiment, the first signal is transmitted through an RRCReestablishmentRequest message.

In one embodiment, the first signal is transmitted through an RRCConnectionSetupRequest message.

In one embodiment, the first signal is transmitted through an RRCConnectionResumeRequest message.

In one embodiment, the first signal is transmitted through an MCGFailureInformation message.

In one embodiment, the first signal is transmitted through an SCGFailureInformation message.

In one embodiment, the first signal is transmitted through a UEAssistanceInformation message.

In one embodiment, the first signal is transmitted through an RRCConnectionReestablishmentRequest message.

In one embodiment, RRC signalings carried by the first signal and the second signal are different.

In one embodiment, the first signal and the second signal are transmitted via different RRC signalings.

In one embodiment, when the node U21a performs the first channel measurement, the node U21a is in a mode other than an RRC connection mode.

In one embodiment, when the node U21a performs the first channel measurement, the node U21a is in an RRC idle mode.

In one embodiment, when the node U21a performs the first channel measurement, the node U21a is in an RRC non-active mode.

In one embodiment, the node U21a performs the first channel measurement in an RRC idle mode.

In one embodiment, the node U21a performs the first channel measurement in an RRC idle state.

In one embodiment, the node U21a transmits the first signal in an RRC connection state.

In one embodiment, indication information carried by the first signal occupies one bit.

In one embodiment, indication information carried by the first signal is a Boolean Variable.

In one embodiment, indication information carried by the first signal is an Enumerative Variable .

In one embodiment, the second signal is used for requesting the first report information group.

In one embodiment, the second signal is used for triggering the first report information group.

In one embodiment, the second signal is used for corresponding to the first signal.

In one embodiment, the second signal comprises configuration information of the first report information group.

In one embodiment, the second signal comprises a filter of a measurement result comprised in the first report information group.

In one embodiment, the filter of the comprised measurement result comprises a filter of time dimension.

In one embodiment, the filter of the comprised measurement result comprises a filter of a threshold.

In one embodiment, the first report information group only comprises a measurement result of the filter greater than the threshold.

In one embodiment, the first report information group only comprises a measurement result of the filter satisfying the time dimension.

In one embodiment, the second signal comprises a parameter used for processing a measurement result.

In one embodiment, the parameter used for processing a measurement result comprised in the second signal is used for processing a result of the first channel measurement.

In one embodiment, the parameter used for processing a measurement result comprised in the second signal is used for processing a result of the second channel measurement.

In one embodiment, the parameter used for processing a measurement result comprises a rolloff coefficient.

In one embodiment, the parameter used for processing a measurement result comprises a smoothing coefficient.

In one embodiment, the parameter used for processing a measurement result comprises a mathematical transform coefficient.

In one embodiment, the mathematical transform coefficient comprises a FFT coefficient.

In one embodiment, the mathematical transform coefficient comprises a DCT coefficient.

In one embodiment, the mathematical transform coefficient comprises a hash coefficient.

In one embodiment, the mathematical transform coefficient comprises a codebook coefficient.

In one embodiment, the second signal comprises a MAC CE.

In one embodiment, the second signal comprises an RRC message.

In one embodiment, the second signal is transmitted through a PDSCH channel.

In one embodiment, the second signal is transmitted through a PDCCH channel.

In one embodiment, the second signal is transmitted via an RRCReconfiguration message.

In one embodiment, the second signal is transmitted via an RRCSetup message.

In one embodiment, the second signal is transmitted via an RRCResume message.

In one embodiment, the first signal is transmitted through an RRCReestablishment message.

In one embodiment, the second signal is transmitted via an RRCConnectionSetup message.

In one embodiment, the second signal is transmitted via an RRCConnectionResume message.

In one embodiment, the second signal is transmitted through a UEAssistanceInformation message.

In one embodiment, when the node N22a receives the first signal, the node N22a transmits the second signal.

In one embodiment, the first condition comprises a periodic triggering and the second signal is received.

In one embodiment, the first condition comprises an event triggering and the second signal is received.

### Embodiment 8A

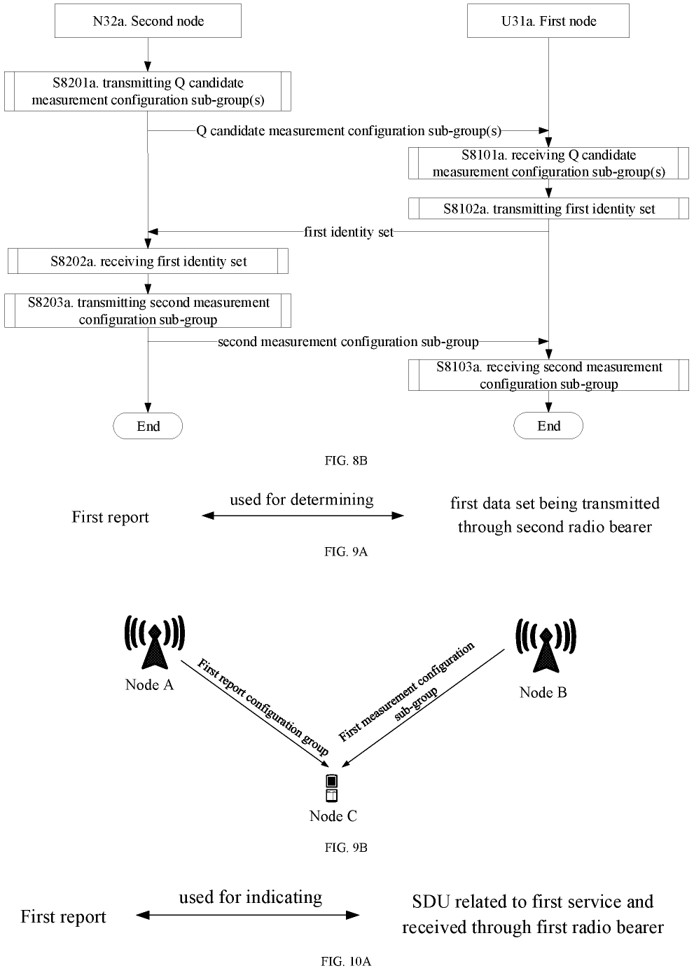

Embodiment 8A illustrates a schematic diagram of first time windows according to one embodiment of the present disclosure, as shown in FIG. 8A.

In one embodiment, the first time window comprises a time lasting in time domain.

In one embodiment, the first time window comprises L1 slot(s), L1 being a positive integer.

In one embodiment, a slot represents a time unit, and the first time window consists of a slot.

In one embodiment, a slot represents a time unit, and the first time window consists of multiple slots with a same time length.

In one embodiment, the L1 is 1024, and the L1 slots are consecutive.

In one embodiment, the L1 is 10240, and the L1 slots are consecutive.

In one embodiment, the L1 is less than 1024, there at least exists one slot interval, and there exists a slot respectively before the slot interval and after the slot interval belonging to the first time window.

In one embodiment, the L1 is less than 10240, there at least exists one slot interval, and there exists a slot respectively before the slot interval and after the slot interval belonging to the first time window.

In one embodiment, a duration of the first slot does not exceed 10485.76 seconds.

In one embodiment, a duration of the first slot does not exceed 10.24 seconds.

In one embodiment, a duration of the first slot does not exceed 10 ms.

In one embodiment, a duration of the first slot does not exceed 5 ms.

In one embodiment, a duration of the first slot does not exceed 1 ms.

In one embodiment, a duration of the first slot does not exceed 0.5 ms.

In one embodiment, the first slot comprises 1 multi-carrier symbol.

In one embodiment, the first slot comprises 7 multi-carrier symbols.

In one embodiment, the first slot comprises 14 multi-carrier symbol.

In one embodiment, the first slot comprises 140 multi-carrier symbol.

In one embodiment, the multicarrier symbol is an Orthogonal Frequency Division Multiplexing (OFDM) symbol.

In one embodiment, the multicarrier symbol is a Cyclic Prefix-Orthogonal Frequency-division Multiplexing (CP-OFDM) symbol.

In one embodiment, the multicarrier symbol is a Single Carrier-Frequency Division Multiple Access (SC-FDMA) symbol.

In one embodiment, the multicarrier symbol is a Filter Bank Multi-Carrier (FBMC) symbol.

In one embodiment, the multicarrier symbol is a Discrete Fourier Transformation-Spread-Orthogonal Frequency Division Multiplexing (DFT-S-OFDM) symbol.

In one embodiment, the multicarrier symbol is a Universal Filtered Multi-Carrier (UFMC) symbol.

In one embodiment, the multicarrier symbol is a Generalized frequency division multiplexing (GFDM) symbol.

### Embodiment 8B

Embodiment 8B illustrates a flowchart of radio signal transmission according to one embodiment in the present disclosure, as shown in FIG. 8B. In FIG. 8B, U31a corresponds to a first node in the present disclosure, N32a corresponds to a second node in the present disclosure. It is particularly underlined that the order illustrated in the embodiment does not put constraints over sequences of signal transmissions and implementations.

The second node N32a transmits Q candidate measurement configuration sub-group(s) in step S8201a;

the first node U31a receives the Q candidate measurement configuration sub-group(s) in step S8101a.

In one embodiment, the node U31a transmits a first identity set in step S8102a.

In one embodiment, the node N32a receives the first identity set in step S8202a.

In one embodiment, the node N32a transmits a second configuration sub-group in step S8203a.

In one embodiment, the node U31a receives a second measurement configuration sub-group in step S8103a.

In Embodiment 8a, the Q candidate measurement configuration sub-group(s) corresponds(respectively correspond) to Q identity(identities), the first identity set comprises Q1 identity(identities), Q and Q1 being positive integers, the Q1 identity(identities) is(are) subset(s) of the Q identity(identities), and the first identity set is used for determining the second measurement configuration sub-group.

In one embodiment, the second measurement configuration sub-group indicates the second reference signal set; and the second measurement configuration sub-group is a unicast upper layer signaling.

In one embodiment, the node U31a performs a second channel measurement on a second reference signal set.

In one embodiment, a first report information group comprises a result of the second channel measurement.

In one embodiment, each the candidate measurement configuration sub-group in the Q candidate measurement configuration sub-group(s) corresponds to one of the Q the identity(identities).

In one embodiment, the identity corresponding to the candidate measurement configuration sub-group can exclusively determine the candidate measurement configuration sub-group.

In one embodiment, Q1<Q.

In one embodiment, Q1=Q.

In one embodiment, the node N32a configures Q1 via an RRC signaling.

In one embodiment, the node U31a determines Q1 according to its own capability.

In one embodiment, the node U31a determines Q1 according to a number of reference signals that can be measured at the same time.

In one embodiment, the node U31a determines Q1 according to a number of reference signals that can be measured within a certain time.

In one embodiment, the node U31a determines Q1 according to internal algorithm.

In one embodiment, the node U31a determines Q1 according to a maximum supported bandwidth.

In one embodiment, the node U31a determines Q1 according to power saving mode.

In one embodiment, when the node U31a is in power saving mode, the determined Q1 is less than a Q1 value determined when the node U31a is in non-power saving mode.

In one embodiment, when the node U31a is in low mobility, the determined Q1 is less than a Q1 value determined when the node U31a is in low mobility mode.

In one embodiment, when the node U31a is in non-cell edge, the determined Q1 is less than a Q1 value determined when the node U31a is in non-cell edge.

In one embodiment, when the node U31a transmits a high priority service, the determined Q1 is less than a Q1 value determined when the node U31a only transmits a low priority service.

In one embodiment, when the node U31a has a high priority bearer, the determined Q1 is less than a Q1 value determined when the node U31a only has a low priority bearer.

In one embodiment, when the node U31a has a low-delay bearer, the determined Q1 is less than a Q1 value determined when the node U31a only has a non-low-delay bearer.

In one embodiment, the node U31a implicitly feeds back the first identity set through feeding back a value of Q1.

In one embodiment, the implicitly feeding back the Q1 identity(identities) includes: the first identity set is first Q1 identity(identities) of the Q identity(identities) corresponding to the Q candidate measurement configuration sub-group(s).

In one embodiment, the implicitly feeding back the Q1 identity(identities) includes: the first identity set is last Q1 identity(identities) of the Q identity(identities) corresponding to the Q candidate measurement configuration sub-group(s).

In one embodiment, the implicitly feeding back the Q1 identity(identities) includes: the first identity set is Q1 even-distributed identity(identities) of the Q identity(identities) corresponding to the Q candidate measurement configuration sub-group(s).

In one embodiment, the implicitly feeding back the Q1 identity(identities) includes: the first identity set is Q1 identity(identities) with highest priority(priorities) of the Q identity(identities) corresponding to the Q candidate measurement configuration sub-group(s).

In one embodiment, the implicitly feeding back the Q1 identity(identities) includes: the first identity set is Q1 identity(identities) related to pilot frequency of the Q identity(identities) corresponding to the Q candidate measurement configuration sub-group(s).

In one embodiment, the implicitly feeding back the Q1 identity(identities) includes: the first identity set is Q1a identity(identities) related to pilot frequency and Q1-Q1a identity(identities) related to same frequency in the Q identity(identities) corresponding to the Q candidate measurement configuration sub-group(s), wherein Q1a is a positive integer.

In one embodiment, the implicitly feeding back the Q1 identity(identities) includes: the first identity set is all Q1b identity(identities) related to pilot frequency with a high priority and Q1-Q1b identity(identities) in the Q identity(identities) corresponding to the Q candidate measurement configuration sub-group(s), wherein Q1b is a positive integer.

In one embodiment, when Q1-Q1b is greater than 0, the Q1-Q1b other identity(identities) comprises(comprise) an identity related to pilot frequency.

In one embodiment, when Q1-Q1b is greater than 0, the Q1-Q1b other identity(identities) comprises(comprise) an identity related to same frequency.

In one embodiment, the identity related to pilot frequency includes: a reference signal indicated by the candidate measurement configuration sub-group associated with the identity related to pilot frequency and a reference signal transmitted by a serving cell of the node U31a belong to different frequencies.

In one embodiment, the identity related to pilot frequency includes: a reference signal indicated by the candidate measurement configuration sub-group associated with the identity related to pilot frequency and an SS/PBCH transmitted by a serving cell and received by the node U31a belong to different frequencies.

In one embodiment, the identity related to pilot frequency includes: a reference signal indicated by the candidate measurement configuration sub-group associated with the identity related to pilot frequency and an active Bandwidth Part (BWP) of the node U31a belong to different frequencies.

In one embodiment, the identity related to pilot frequency includes: a reference signal indicated by the candidate measurement configuration sub-group associated with the identity related to pilot frequency and a default BWP of the node U31a belong to different frequencies.

In one embodiment, the identity related to same frequency includes: a reference signal indicated by the candidate measurement configuration sub-group associated with the identity related to pilot frequency and a reference signal transmitted by a serving cell of the node U31a belong to a same frequency band.

In one embodiment, the identity related to same frequency includes: a reference signal indicated by the candidate measurement configuration sub-group associated with the identity related to pilot frequency and an SS/PBCH transmitted by a serving cell and received by the node U31a belong to a same frequency band.

In one embodiment, the identity related to same frequency includes: a reference signal indicated by the candidate measurement configuration sub-group associated with the identity related to pilot frequency and an active Bandwidth Part (BWP) of the node U31a belong to a same frequency band.

In one embodiment, the identity related to same frequency includes: a reference signal indicated by the candidate measurement configuration sub-group associated with the identity related to pilot frequency and a default BWP of the node U31a belong to a same frequency band.

In one embodiment, each the candidate measurement configuration sub-group in the Q candidate measurement configuration sub-group(s) only comprises a measurement configuration item.

In one embodiment, the node U31a randomly selects Q1 candidate measurement configuration sub-group(s) out of the Q candidate measurement configuration sub-group(s), and Q1 identity(identities) corresponding to the Q1 candidate measurement configuration sub-group(s) is(are) the first identity set.

In one embodiment, each identity in the Q identity(identities) is an integer, the node U31a selects Q1 candidate measurement configuration sub-group(s) out of the Q candidate measurement configuration sub-group(s), Q1 identity (identities) corresponding to the Q1 candidate measurement configuration sub-group(s) is(are) smallest Q1 identity(identities), and the Q1 identity(identities) is(are) the first identity set.

In one embodiment, each identity in the Q identity(identities) is an integer, the node U31a selects Q1 candidate measurement configuration sub-group(s) out of the Q candidate measurement configuration sub-group(s), Q1 identity (identities) corresponding to the Q1 candidate measurement configuration sub-group(s) is(are) largest Q1 identity(identities) in the Q identity(identities), and the Q1 identity(identities) is(are) the first identity set.

In one embodiment, the node N32a determines the second measurement configuration sub-group according to internal algorithm.

In one embodiment, the node N32a determines the second measurement configuration sub-group according to the first identity set.

In one embodiment, the node N32a determines a received candidate measurement configuration sub-group corresponding to the first identity set as the second measurement configuration sub-group.

In one embodiment, the node N32a determines part of candidate measurement configuration sub-groups of a received candidate measurement configuration sub-group corresponding to the first identity set as the second measurement configuration sub-group.

In one embodiment, the node N32a determines a candidate measurement configuration sub-group related to a pilot frequency measurement in a received candidate measurement configuration sub-group corresponding to the first identity set as the second measurement configuration sub-group.

### Embodiment 9A

Embodiment 9A illustrates a schematic diagram of a first report used for determining that a first data set is transmitted through a second radio bearer according to one embodiment of the present disclosure, as shown in FIG. 9A.

In one embodiment, the first report is used for indicating an SDU related to the first service and received through the first radio bearer.

In one embodiment, a transmitter of the first service determines the first data set according to internal algorithm after receiving the first report.

In one embodiment, the first report indicates data that has been transmitted through the first radio bearer but not received by the first node, a transmitter of the first service takes the data not received by the first node as the first data set and transmits it through the second radio bearer.

In one embodiment, a transmitter of the first service determines data belonging to a specific time window in an SDU indicated by the first report, related to the first service and received through the first radio bearer as the first data set.

In one subembodiment of the embodiment, the specific time window comprises L2 frame(s), wherein L2 is a positive integer.

In one subembodiment of the embodiment, the specific time window comprises 1024 frames.

In one subembodiment of the embodiment, the specific time window comprises a last MCCH modification period.

In one subembodiment of the embodiment, the specific time window comprises a last SC-MCCH modification period.

In one subembodiment of the embodiment, the specific time window comprises a last SC-MCCH modification period.

In one subembodiment of the embodiment, the specific time window comprises a last SC-MTCH scheduling period.

In one subembodiment of the embodiment, the specific time window is determined by a QoS of the first service, and only a packet less than a maximum delay request is comprised in the first data set.

In one embodiment, the first report is a PDCP status report, and the first data set comprises all unreceived PDCU SDUs indicated by the first report.

In one embodiment, the first report is a PDCP status report, and the first data set comprises part of unreceived PDCU SDUs indicated by the first report.

### Embodiment 9B

Embodiment 9B illustrates a schematic diagram of a first measurement configuration sub-group and a first report configuration group according to one embodiment of the present disclosure, as shown in FIG. 9B. In Embodiment 9B, a node C corresponds to a first node in the present disclosure.

In one embodiment, a node A is a PCell of the node C.

In one embodiment, a node B is an SCell of the node C.

In one embodiment, a node B is a PCell of the node C.

In one embodiment, a node A is an SCell of the node C.

In one embodiment, the node A is a PSCell of the node C.

In one embodiment, the node B is a PSCell of the node C.

In one embodiment, the node A is a cell in a Master Cell Group (MCG) of the node C.

In one embodiment, the node B is a cell in a Secondary Cell Group (SCG) of the node C.

In one embodiment, the node A is a Master Node (MN).

In one embodiment, the node B is a Secondary Node (SN).

In one embodiment, the node B is an MN.

In one embodiment, the node A is an SN.

In one embodiment, the first measurement configuration sub-group is transmitted by the node B.

In one embodiment, the first report configuration group is transmitted by the node A.

In one embodiment, there is only an SRBO between the node C and the node B, and there is an SRB other than the SRBO between the node C and the node A.

In one embodiment, the node B is in a non-activate state for the node C.

In one embodiment, the node C is in a suspended state in an SRB other than an SRBO in the node B.

### Embodiment 10A

Embodiment 10A illustrates a schematic diagram of a first report used for indicating an SDU related to a first service and received through a first radio bearer according to one embodiment of the present disclosure, as shown in 10A.

In one embodiment, an SDU related to the first service and received through a first radio bearer comprises a PDCP SDU of a user plane of the first service.

In one embodiment, the first report indicates an SDU related to a first service and received through a first radio bearer, and a transmitter of the first service determines an SDU not received by the first node according to the first report.

In one embodiment, the first report indicates an SDU related to a first service and not received through a first radio bearer, and a transmitter of the first service determines an SDU that has been received by the first node according to the first report.

In one embodiment, the first report indicates an SDU related to a first service and received through a first radio bearer and an SDU related to a first service and not received through a first radio bearer.

In one embodiment, the first report comprises an RRC signaling.

In one embodiment, the first report indicates an SN of a last received PDCP SDU.

In one embodiment, the first report indicates a maximum one of received COUNT values of a PDCP SDU.

In one embodiment, an SDU related to the first service and received through a first radio bearer comprises an SDU of multicast service SIB related to the first service.

In one subembodiment of the embodiment, the first report indicates a time window of the multicast service SIB, the time window corresponds to a modification period of the multicast service SIB, and data of the first service within and before the time window of the multicast service SIB is assumed to have been correctly received.

In one embodiment, an SDU related to the first service and received through a first radio bearer comprises an SDU of an RRC message on an MCCH related to the first service.

In one subembodiment of the embodiment, the first report indicates a time window of an RRC message on the MCCH, the time window corresponds to a modification period of an RRC message on the MCCH, and data of the first service within and before the time window of an RRC message on the MCCH is assumed to have been correctly received.

In one embodiment, an SDU related to the first service and received through a first radio bearer comprises an SDU on a multicast service channel related to the first service.

In one subembodiment of the embodiment, the first report indicates a time window of an SDU on the multicast service channel, the time window corresponds to a scheduling period of an SDU on the multicast service channel, and data of the first service within and before the time window of an SDU on the multicast service channel is assumed to have been correctly received.

### Embodiment 10B

Embodiment 10B illustrates a schematic diagram of a first measurement configuration sub-group associated with a first radio bearer according to one embodiment of the present disclosure, as shown in FIG. 10B.

In one embodiment, the first measurement configuration sub-group is associated with the first radio bearer, and the first radio bearer is used for bearing a non-unicast data service.

In one embodiment, a reference signal indicated by the first measurement configuration sub-group is used for receiving data of the first radio bearer.

In one embodiment, a reference signal indicated by the first measurement configuration sub-group is used for demodulating data of the first radio bearer.

In one embodiment, a reference signal indicated by the first measurement configuration sub-group is used for estimating a radio channel of data of the first radio bearer.

In one embodiment, a reference signal indicated by the first measurement configuration sub-group and time-frequency resources occupied by data of the first radio bearer are multiplexed in time and frequency.

In one embodiment, the first measurement configuration sub-group is transmitted through the first radio bearer.

In one embodiment, the first measurement configuration sub-group is mapped onto the first radio bearer.

In one embodiment, an RRC message used for transmitting the first measurement configuration sub-group is used for configuring the first radio bearer.

In one embodiment, an RRC message used for carrying the first measurement configuration sub-group is used for carrying configuration of the first radio bearer.

In one embodiment, the first measurement configuration sub-group is used for measuring receive quality of data of the first radio bearer.

In one embodiment, the first measurement configuration sub-group is used for measuring receive quality of data carried by the first radio bearer.

In one embodiment, the first node performs a hypothetical measurement according to the first channel measurement performed on the first reference signal set to estimate receive quality of data carried by the first radio bearer, and the first report information group comprises the receive quality.

In one embodiment, a result of the first channel measurement comprises a result obtained by a hypothetical measurement performed by the first node.

In one embodiment, the receive quality of the carried data comprises a BLER.

In one embodiment, the receive quality of the carried data comprises a time delay.

In one embodiment, the receive quality of the carried data comprises a throughput rate.

In one embodiment, the receive quality of the carried data comprises a peak rate.

In one embodiment, the receive quality of the carried data comprises a delay jitter.

In one embodiment, the receive quality of the carried data comprises a BLER.

In one embodiment, the receive quality of the carried data comprises a packet missing probability.

In one embodiment, the receive quality of the carried data comprises an interruption rate.

In one embodiment, the receive quality of the carried data comprises a channel busy rate.

In one embodiment, the first condition includes that the first node is receiving data carried by the first radio bearer.

In one embodiment, the first condition includes that the first node has received data carried by the first radio bearer.

In one embodiment, the first condition includes that the first node is interested in data carried by the first radio bearer.

In one embodiment, the first node performs the first radio channel measurement in the process of receiving service carried by the first radio bearer.

In one embodiment, the first node performs the first radio channel measurement when the first node is interested in service carried by the first radio bearer.

In one embodiment, the first radio bearer is used for transmitting a Multimedia Broadcast Multicast Service (MBMS).

In one embodiment, the first radio bearer is used for transmitting a Cell Broadcast Service (CBS).

In one embodiment, the first radio bearer is used for transmitting a Public Warning System Service (PWS).

In one embodiment, the first radio bearer is used for transmitting a Single Cell-Point to Multipoint (SC-PTM) service.

In one embodiment, the first radio bearer comprises an MBMS Radio Bearer (MRB).

In one embodiment, the first radio bearer comprises an SC-PTM bearer.

### Embodiment 11

Embodiment 11 illustrates a structure block diagram of a processing device in a first node according to one embodiment of the present disclosure; as shown in FIG. 11. In FIG. 11, a processing device 1100 in a first node comprises a first receiver 1101 and a first transmitter 1102. In Embodiment 11,

the first receiver 1101 receives a first service through a first radio bearer; and receives a first signaling, the first signaling indicates establishing a second radio bearer for the first service;

the first transmitter 1102 transmits a first report; and

the first receiver 1101 receives the first service through at least a latter of the first radio bearer and the second radio bearer;

herein, when a first condition is satisfied, the first transmitter 1102 transmits the first report; the first condition comprises that a reception of the first service is modified from the first radio bearer to the second radio bearer; a bearer type of the first radio bearer is different from a bearer type of the second radio bearer, and the bearer type comprises a non-unicast bearer and a unicast bearer; the first report is used for indicating an SDU related to the first service and received through the first radio bearer, and the first report is upper layer control information.

In one embodiment, the first report is an RRC signaling, the first report comprises a first identity, the first identity is used for determining a PDCP SDU related to the first service and received after a first missing PDCP SDU through the first radio bearer.

In one embodiment, the first report is an RRC signaling, the first report comprises a second identity, the second identity is used for determining a first time window, and the first time window is a time window related to the first service and corresponding to a last SDU received through the first radio bearer.

In one embodiment, the first report is a PDCP status report, a first status variable group is a subset of a set consists of all status variables of a PDCP entity associated with the second radio bearer, and the first signaling indicates that a value of a status variable in the first status variable group is determined by a value of a status variable of a PDCP entity associated with the first radio bearer; the first transmitter 1102 generates the first report according to a PDCP entity associated with the second radio bearer, and the first transmitter 1102 transmits the first report through a radio bearer whose bearer type is unicast bearer in the first radio bearer and the second radio bearer.

In one embodiment, the first report is a PDCP status report, the first transmitter 1102 generates the first report according to a PDCP entity associated with the first radio bearer, and the first transmitter 1102 transmits the first report through a radio bearer whose bearer type is unicast bearer in the first radio bearer and the second radio bearer.

In one embodiment, the first receiver 1101 receives a second signaling;

the second signaling indicates that a transmission of the first service is modified from the first radio bearer to the second radio bearer.

In one embodiment, the first transmitter 1102 transmits first information, and the first information is used for triggering the first signaling.

In one embodiment, the first receiver 1101 receives a first data set through the first radio bearer and the second radio bearer respectively, and the first report is used for determining that the first data set is transmitted through the second radio bearer.

In one embodiment, the first node is a UE.

In one embodiment, the first node is a terminal that supports large delay difference.

In one embodiment, the first node is a terminal that supports NTN.

In one embodiment, the first node is an aircraft.

In one embodiment, the first node is a vehicle terminal.

In one embodiment, the first node is a relay.

In one embodiment, the first node is a vessel.

In one embodiment, the first node is a IoT terminal.

In one embodiment, the first node is a IIoT terminal.

In one embodiment, the first node is a device that supports transmission with low-latency and high-reliability.

In one embodiment, the first receiver 1101 comprises at least one of the antenna 452, the receiver 454, the receiving processor 456, the multi-antenna receiving processor 458, the controller/processor 459, the memory 460 or the data source 467 in Embodiment 4.

In one embodiment, the first transmitter 1102 comprises at least one of the antenna 452, the transmitter 454, the transmitting processor 468, the multi-antenna transmitting processor 457, the controller/processor 459, the memory 460 or the data source 467 in Embodiment 4.

### Embodiment 12

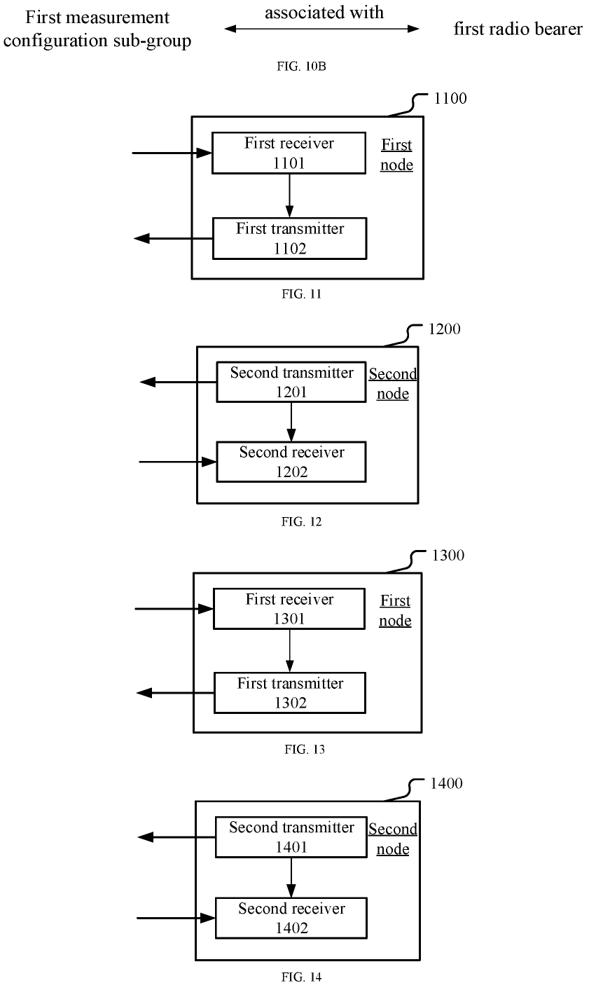

Embodiment 12 illustrates a structure block diagram of a processing device in a second node according to one embodiment of the present disclosure; as shown in FIG. 12. In FIG. 12, a processing device 1200 in a second node comprises a second transmitter 1201 and a second receiver 1202. In Embodiment 12,

the second transmitter 1201 transmits a first signaling, and the first signaling indicates a second radio bearer establishing a first service; the first service is transmitted through a first radio bearer;

the second receiver 1202 receives a first report; and

a receiver of the first signaling receives the first service through at least a latter of the first radio bearer and the second radio bearer;

herein, when a first condition is satisfied, the receiver of the first signaling transmits the first report; the first condition comprises that a reception of the first service is modified from the first radio bearer to the second radio bearer; a bearer type of the first radio bearer is different from a bearer type of the second radio bearer, and the bearer type comprises a non-unicast bearer and a unicast bearer; the first report is used for indicating an SDU related to the first service and received through the first radio bearer, and the first report is upper layer control information.

In one embodiment, the first report is an RRC signaling, the first report comprises a first identity, the first identity is used for determining a PDCP SDU related to the first service and received after a first missing PDCP SDU through the first radio bearer.

In one embodiment, the first report is an RRC signaling, the first report comprises a second identity, the second identity is used for determining a first time window, and the first time window is a time window related to the first service and corresponding to a last SDU received through the first radio bearer.

In one embodiment, the first report is a PDCP status report, a first status variable group is a subset of a set consists of all status variables of a PDCP entity associated with the second radio bearer, and the first signaling indicates that a value of a status variable in the first status variable group is determined by a value of a status variable of a PDCP entity associated with the first radio bearer; a transmitter of the first report generates the first report according to a PDCP entity associated with the second radio bearer, and the transmitter of the first report transmits the first report through a radio bearer whose bearer type is unicast bearer in the first radio bearer and the second radio bearer.

In one embodiment, the first report is a PDCP status report, a transmitter of the first report generates the first report according to a PDCP entity associated with the first radio bearer, and the transmitter of the first report transmits the first report through a radio bearer whose bearer type is unicast bearer in the first radio bearer and the second radio bearer.

In one embodiment, the second transmitter 1201 transmits a second signaling;

the second signaling indicates that a transmission of the first service is modified from the first radio bearer to the second radio bearer.

In one embodiment, the second receiver receives first information, and the first information is used for triggering the first signaling.

In one embodiment, the second transmitter 1201 transmits a first data set through the first radio bearer and the second radio bearer respectively, and the first report is used for determining that the first data set is transmitted through the second radio bearer.

In one embodiment, the second node is a base station.

In one embodiment, the second node is a satellite.

In one embodiment, the second node is a UE.

In one embodiment, the second node is a gateway.

In one embodiment, the second node is a base station that supports large delay difference.

In one embodiment, the second transmitter 1201 comprises at least one of the antenna 420, the transmitter 418, the transmitting processor 416, the multi-antenna transmitting processor 471, the controller/processor 475 or the memory 476 in Embodiment 4.

In one embodiment, the second receiver 1202 comprises at least one of the antenna 420, the receiver 418, the receiving processor 470, the multi-antenna receiving processor 472, the controller/processor 475 or the memory 476 in Embodiment 4.

### Embodiment 13

Embodiment 13 illustrates a structure block diagram of a processing device in a first node according to one embodiment of the present disclosure; as shown in FIG. 13. In FIG. 13, the first node’s processing device 1300 comprises a first receiver 1301 and a first transmitter 1302. In Embodiment 13,

the first receiver 1301, receives a first measurement configuration group and a first report configuration group; and performs a first channel measurement on a first reference signal set;

the first transmitter 1302, determines that a first condition is satisfied, as a response that the first condition is satisfied, transmits a first report information group, the first report configuration group indicates the first condition;

herein, the first measurement configuration group comprises a first measurement configuration sub-group; the first measurement configuration sub-group indicates the first reference signal set; the first measurement configuration sub-group is a non-unicast upper layer signaling, and the first report configuration group is a unicast upper layer signaling; and the first report information group comprises a result of the first channel measurement.

In one embodiment, a second channel measurement is performed on a second reference signal set;

herein, the first measurement configuration group comprises a second measurement configuration sub-group; the second measurement configuration sub-group indicates the second reference signal set; the second measurement configuration sub-group is a unicast upper layer signaling; the first report information group comprises a result of the second channel measurement.

In one embodiment, the first channel measurement on the first reference signal set is performed in a first time window; and the second channel measurement on the second reference signal set is performed in a second time window.

In one embodiment, the first receiver 1301 receives Q candidate measurement configuration sub-group(s); the first transmitter 1302 transmits a first identity set;

herein, the Q candidate measurement configuration sub-group(s) comprises(respectively comprise) Q identity(identities), the first identity set comprises Q1 identity(identities), Q and Q1 being positive integers, the Q1 identity(identities) is(are) subset(s) of the Q identity (identities), and the first identity set is used for determining the second measurement configuration sub-group.

In one embodiment, a transmission delay from the second reference signal set to the first node is less than a first threshold; and a transmission delay from the first reference signal set to the first node is not less than the first threshold.

In one embodiment, a transmitter of the first measurement configuration sub-group and the transmitter of the first report configuration group are two serving cells.

In one embodiment, the first measurement configuration sub-group is associated with a first radio bearer, and the first radio bearer is used for bearing non-unicast data service.

In one embodiment, the first receiver 1301 receives first time information, the first time information is used for determining the first report information group.

In one embodiment, the first transmitter 1302 transmits a first signal; and the first receiver 1301 receives a second signal;

herein, the first signal is used for triggering the second signal, and the first condition includes that the second signal is received.

In one embodiment, the first node is a UE.

In one embodiment, the first node is a terminal that supports large delay difference.

In one embodiment, the first node is a terminal that supports NTN.

In one embodiment, the first node is an aircraft.

In one embodiment, the first node is a vehicle terminal.

In one embodiment, the first node is a relay.

In one embodiment, the first node is a vessel.

In one embodiment, the first node is a IoT terminal.

In one embodiment, the first node is a IIoT terminal.

In one embodiment, the first node is a device that supports transmission with low-latency and high-reliability.

In one embodiment, the first receiver 1301 comprises at least one of the antenna 452, the receiver 454, the receiving processor 456, the multi-antenna receiving processor 458, the controller/processor 459, the memory 460 or the data source 467 in Embodiment 4.

In one embodiment, the first transmitter 1302 comprises at least one of the antenna 452, the transmitter 454, the transmitting processor 468, the multi-antenna transmitting processor 457, the controller/processor 459, the memory 460 or the data source 467 in Embodiment 4.

### Embodiment 14

Embodiment 14 illustrates a structure block diagram of a processing device in a second node according to one embodiment of the present disclosure; as shown in FIG. 14. In FIG. 14, the second node's processing device 1400 comprises a second transmitter 1401 and a second receiver 1402. In Embodiment 14,

the first transmitter 1401, transmits a first measurement configuration group and a first report configuration group;

the second receiver 1402, receives a first report information group, the first report configuration group indicates a first condition; the first condition is used for triggering a transmission of the first report information group;

herein, the first measurement configuration group comprises a first measurement configuration sub-group; the first measurement configuration sub-group indicates a first reference signal set; the first reference signal set is used for performing a first channel measurement; the first measurement configuration sub-group is a non-unicast upper layer signaling, and the first report configuration group is a unicast upper layer signaling; the first report information group comprises a result of the first channel measurement.

In one embodiment, a receiver of the first measurement configuration group performs a second channel measurement on a second reference signal set;

herein, the first measurement configuration group comprises a second measurement configuration sub-group; the second measurement configuration sub-group indicates the second reference signal set; the second measurement configuration sub-group is a unicast upper layer signaling; and the first report information group comprises a result of the second channel measurement.

In one embodiment, the first channel measurement on the first reference signal set is performed by a receiver of the first measurement configuration group in a first time window; the second channel measurement on the second reference signal set is performed by a receiver of the first measurement configuration group in a second time window.

In one embodiment, the second transmitter 1401 transmits Q candidate measurement configuration sub-group(s); and the second receiver 1402 receives a first identity set;

herein, the Q candidate measurement configuration sub-group(s) comprises(respectively comprise) Q identity(identities), the first identity set comprises Q1 identity(identities), Q and Q1 being positive integers, the Q1 identity(identities) is(are) subset(s) of the Q identity (identities), and the first identity set is used for determining the second measurement configuration sub-group.

In one embodiment, a transmission delay from the second reference signal set to a receiver of the first measurement configuration group is less than a first threshold; and a transmission delay from the first reference signal set to a receiver of the first measurement configuration group is not less than the first threshold.

In one embodiment, the first measurement configuration sub-group is associated with a first radio bearer, and the first radio bearer is used for bearing a non-unicast data service.

In one embodiment, the second transmitter 1401 transmits first time information, the first time information is used for determining the first report information group.

In one embodiment, the second receiver 1402 receives a first signal; the second transmitter 1401 transmits a second signal;

herein, the first signal is used for triggering the second signal, and the first condition includes that the second signal is received.

In one embodiment, the second node is a base station.

In one embodiment, the second node is a satellite.

In one embodiment, the second node is a UE.

In one embodiment, the second node is a gateway.

In one embodiment, the second node is a base station that supports large delay difference.

In one embodiment, the second transmitter 1401 comprises at least one of the antenna 420, the transmitter 418, the transmitting processor 416, the multi-antenna transmitting processor 471, the controller/processor 475 or the memory 476 in Embodiment 4.

In one embodiment, the second receiver 1402 comprises at least one of the antenna 420, the receiver 418, the receiving processor 470, the multi-antenna receiving processor 472, the controller/processor 475 or the memory 476 in Embodiment 4.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present disclosure is not limited to any combination of hardware and software in specific forms. The UE and terminal in the present disclosure include but not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things, RFID terminals, NB-IOT terminals, Machine Type Communication (MTC) terminals, enhanced MTC (eMTC) terminals, data cards, low-cost mobile phones, low-cost tablet computers, satellite communication equipment, vessel communication equipment, NTN UEs, etc. The base station or system device in the present disclosure includes but is not limited to macro-cellular base stations, micro-cellular base stations, home base stations, relay base station, gNB (NR node B), Transmitter Receiver Point (TRP), NTN base stations, satellite equipment, flight platform equipment and other radio communication equipment.

The above are merely the preferred embodiments of the present disclosure and are not intended to limit the scope of protection of the present disclosure. Any modification, equivalent substitute and improvement made within the spirit and principle of the present disclosure are intended to be included within the scope of protection of the present disclosure.

What is claimed is:

1. A first node for wireless communications, comprising:
a first receiver, receives a first measurement configuration group and a first report configuration group; and performs a first channel measurement on a first reference signal set;
a first transmitter, determines that a first condition is satisfied, as a response that the first condition is satisfied, transmits a first report information group, the first report configuration group indicates the first condition;
herein, the first measurement configuration group comprises a first measurement configuration sub-group; the first measurement configuration sub-group indicates the first reference signal set; the first measurement configuration sub-group is a non-unicast upper layer signaling, and the first report configuration group is a unicast upper layer signaling; and the first report information group comprises a result of the first channel measurement.

2. The first node according to claim 1, comprising:
the first receiver, performs a second channel measurement on a second reference signal set;
herein, the first measurement configuration group comprises a second measurement configuration sub-group; the second measurement configuration sub-group indicates the second reference signal set; the second measurement configuration sub-group is a unicast upper layer signaling; the first report information group comprises a result of the second channel measurement.

3. The first node according to claim 1, wherein the first measurement configuration sub-group is an SIB (System information Block); the first measurement configuration group and the first report configuration group are encapsulated in different RRC (Radio Resource Control) layer signalings.

4. The first node according to claim 3, wherein when the first report information group is transmitted through a PUSCH (Physical Uplink Shared Channel), the first node is in an RRC inactive mode.

5. The first node according to claim 3, wherein when the first measurement configuration sub-group is transmitted through a PDSCH (Physical Downlink Shared Channel) channel, the first node is in an RRC inactive mode.

6. The first node according to claim 3, wherein the first node is in an RRC inactive mode.

7. The first node according to claim 3, wherein when the first node performs the first channel measurement, the first node is in an RRC inactive mode.

8. The first node according to claim 3, wherein the first measurement configuration sub-group comprises a time parameter D1, and the D1 is used for controlling the first channel measurement.

9. The first node according to claim 4, wherein the first measurement configuration sub-group comprises a time parameter D1, and the D1 is used for controlling the first channel measurement.

10. The first node according to claim 5, wherein the first measurement configuration sub-group comprises a time parameter D1, and the D1 is used for controlling the first channel measurement.

11. The first node according to claim 6, wherein the first measurement configuration sub-group comprises a time parameter D1, and the D1 is used for controlling the first channel measurement.

12. The first node according to claim 6, wherein the first node is in different RRC modes when receiving the second measurement configuration sub-group and performing a second channel measurement on a first reference signal set.

13. The first node according to claim 3, wherein the first node is in different RRC modes when receiving the second measurement configuration sub-group and performing a second channel measurement on a first reference signal set.

14. The first node according to claim 11, wherein the first measurement configuration group comprises N measurement item(s), wherein N is a positive integer; the first measurement configuration sub-group indicates each reference signal in the first reference signal set and its corresponding cell identity.

15. The first node according to claim 3, comprising:
the first receiver, receives a first time information, the first time information is used for determining the first report information group, the measurement performed by the first node within a latest time indicated by the first time information comprises the first channel measurement.

16. The first node according to claim 7, comprising:
the first receiver, receives a first time information, the first time information is used for determining the first report information group, the measurement performed by the first node within a latest time indicated by the first time information comprises the first channel measurement.

17. The first node according to claim 14, comprising:
the first receiver, receives a first time information, the first time information is used for determining the first report information group, the measurement performed by the first node within a latest time indicated by the first time information comprises the first channel measurement.

18. The first node according to claim 16, comprising:
the first channel measurement comprises a Reference Signal Receiving Power (RSRP) measurement performed on the first reference signal set.

19. The first node according to claim 18, comprising:
the first report information group comprises multiple report information sub-groups, and the multiple report information sub-groups respectively correspond to the multiple measurement configuration sub-groups.

20. A method in a first node for wireless communications, comprising:
receiving a first measurement configuration group and a first report configuration group; and performs a first channel measurement on a first reference signal set;
determining that a first condition is satisfied, as a response that the first condition is satisfied, transmitting a first report information group, the first report configuration group indicates the first condition;
herein, the first measurement configuration group comprises a first measurement configuration sub-group; the first measurement configuration sub-group indicates the first reference signal set; the first measurement configuration sub-group is a non-unicast upper layer signaling, and the first report configuration group is a unicast upper layer signaling; and the first report information group comprises a result of the first channel measurement.
